(19) United States
(12) Patent Application Publication
(10) Pub. No.: US 2023/0333431 A1
(43) Pub. Date: Oct. 19, 2023

(54) LIQUID CRYSTAL TUNABLE SINGLE-COAXIAL AND BICOAXIAL METAMATERIAL ELEMENTS

(71) Applicant: Neurophos LLC, Durham, NC (US)

(72) Inventors: Patrick T. Bowen, Austin, TX (US); Tom Driscoll, San Diego, CA (US); Andrew J. Traverso, Durham, NC (US)

(21) Appl. No.: 18/343,882

(22) Filed: Jun. 29, 2023

Related U.S. Application Data
(63) Continuation of application No. PCT/US2022/013019, filed on Jan. 19, 2022.
(60) Provisional application No. 63/140,780, filed on Jan. 22, 2021.

(51) Int. Cl. G02F 1/1343; G02F 1/133

(52) U.S. Cl. CPC G02F 1/13439; G02F 1/13306; G02F 2202/30

(57) ABSTRACT

This document is a disclosure of two related classes of metamaterial elements, based on a set of planar geometries that are homeomorphic to a coaxial element, or a sphere together with a torus. These cavities support a set of lossy optical resonances, known as quasinormal modes. Depending on the surrounding materials and the choice of quasinormal mode, the optical elements can be used either in transmission or reflection mode, and to generate either effective electric or magnetic dipoles. The metamaterial element is defined as a cavity with coaxial topology to operate in a particular range of quasinormal modes, defined by the mode numbers, within an operating bandwidth. The elements are tuned by application of a voltage differential to liquid crystal placed in the interior of the cavity of each respective element.

### RELATED APPLICATIONS

This application is a continuation of PCT Application No. PCT/US2022/013019, filed on Jan. 19, 2022, titled “Liquid Crystal Tunable Single-Coaxial and Bicoaxial Metamaterial Elements,” which claims benefit of and priority to U.S. Provisional Patent Application No. 63/140,780 titled “Liquid Crystal Tunable Coaxial and Double Coaxial Metamaterial Elements,” filed on Jan. 22, 2021, which application is hereby incorporated by reference in its entirety.

### TECHNICAL FIELD

This application relates to metamaterial elements. More particularly, this application relates to liquid crystal metamaterials.

### BRIEF DESCRIPTION OF THE DRAWINGS

FIG. 1 illustrates a graphical depiction of the field equivalence principle, according to one embodiment.

FIG. 2 illustrates various views of a single coaxial resonator metamaterial element, according to one embodiment.

FIG. 3 illustrates a cross section of a circular coaxial resonator metamaterial element, according to one embodiment.

FIG. 4 illustrates a cross section of a rectangular coaxial resonator metamaterial element, according to one embodiment.

FIG. 5 illustrates a graphical illustration of magnetic dipolar scattering in a coaxial resonator metamaterial element, according to one embodiment.

FIG. 6 illustrates a graphical illustration of magnetic dipolar scattering in a coaxial resonator metamaterial element with an optical isolation structure, according to one embodiment.

FIG. 7 illustrates a full-wave simulation boundary condition for polarizability extraction using scattering parameters, according to one embodiment.

FIG. 8 illustrates a graph of a reflectance spectrum of a metasurface comprising a plurality of coaxial resonator metamaterial elements, according to one embodiment.

FIG. 9 illustrates a graph of the extracted magnetic polarizability of a single coaxial resonator metamaterial element, according to one embodiment.

FIG. 10 illustrates a graph of the extracted electromagnetic polarizability of a single coaxial resonator metamaterial element, according to one embodiment.

FIG. 11 illustrates a graph of the imaginary part of the magnetic polarizability of a single coaxial resonator metamaterial element, according to one embodiment.

FIG. 12 illustrates a graph of the imaginary part of a bianisotropic polarizability of a single coaxial resonator metamaterial element with respect to a variable liquid crystal refractive index, according to one embodiment.

FIG. 13 illustrates a polar graph of a complex valued reflection coefficient of a metasurface of an arrangement of coaxial resonator metamaterial elements, according to one embodiment.

FIG. 14 illustrates a polar graph of a complex valued transmission coefficient of a metasurface of coaxial resonator metamaterial elements, according to one embodiment.

FIG. 15 illustrates another polar graph of a complex valued reflection coefficient of a metasurface of coaxial resonator metamaterial elements, according to one embodiment.

FIG. 16 illustrates another polar graph of a complex valued transmission coefficient of a metasurface of coaxial resonator metamaterial element, according to one embodiment.

FIG. 17 illustrates a block diagram of a receive coaxial resonator metamaterial element with an optical isolation structure, according to one embodiment.

FIG. 18 illustrates a block diagram of electromagnetic equivalence with the coaxial resonator metamaterial element of FIG. 17, according to one embodiment.

FIG. 19 illustrates a graph of the real part of the polarizability showing a linear shift in resonance frequency as a function of liquid crystal refractive index, according to one embodiment.

FIG. 20 illustrates a graph of the imaginary part of the polarizability showing a linear shift in the resonance frequency as a function of liquid crystal refractive index, according to one embodiment.

FIG. 21 illustrates a polar graph of a complex valued optical isolation performance, according to one embodiment.

FIG. 22 illustrates a block diagram of an optical isolation layer, according to one embodiment.

FIG. 23 illustrates a block diagram of another optical isolation layer, according to an alternative embodiment.

FIG. 24 illustrates various views of a bicoaxial resonator metamaterial element filled with liquid crystal, according to one embodiment.

### DETAILED DESCRIPTION

The presently described systems and methods leverage dynamically tunable scattering properties of metamaterial elements. Liquid crystal is dynamically tunable; however, the overall impact on an electromagnetic field is relatively weak on a per-unit volume basis. The presently described systems and methods include resonant electromagnetic cavities in metamaterial elements that significantly increase the impact on the electromagnetic field, which can be described by quasinormal mode expansion and associated equations of motion of the mode amplitudes. When liquid crystal is placed in an interior cavity and a director of the liquid crystal is rotated, the resonance spectrum of the cavity is shifted, which significantly changes how the cavity scatters an electromagnetic field. The cavity amplifies the effect that the liquid crystal has on the electromagnetic field. The presently described systems and methods utilize tunable liquid crystal to control and manipulate the strong scattering capabilities of a resonant cavity.

The presently described systems and methods include two different classes of metamaterial elements, based on a set of planar geometries that are homeomorphic to a coaxial element (or a sphere together with a torus). Depending on the surrounding materials and the choice of quasinormal mode, this class of elements can be used either in transmission or reflection modes, and to generate either effective electric or magnetic dipoles. Each metamaterial element includes a cavity with coaxial topology configured such that any one of a particular range of quasinormal modes (defined by the mode numbers) are within an operational bandwidth. Liquid crystal placed in the interior of the cavity allows this mode to be tuned.

The presently described systems and methods include various metasurfaces of one-dimensional and two-dimensional arrays or other arrangements of dynamically tunable resonant structures. In various embodiments, the dynamically tunable resonant structures comprise a conductive outer shell within which a ring-shaped cavity is formed and filled with liquid crystal. A conductive core remains centered within the ring-shaped cavity. The resonance properties of the ring-shaped cavity can be manipulated by applying a voltage differential between the coaxial core and the outer conductive shell. Application of the voltage differential causes the liquid crystal to rotate and modifies the refractive index thereof.

According to various embodiments, a coaxial resonant metamaterial structure includes a first conductive material that forms an outer shell. A ring-shaped cavity formed in the first conductive material extends through the first conductive material between a first surface of the first conductive material and a second, opposing surface of the first conductive material. A coaxial core of a second conductive material (that can be the same material as the first conductive material, in some embodiments) is coaxial with the ring-shaped cavity and extends between the first surface and second, opposing surface of the outer shell. Liquid crystal is deposited within the cavity. Changes to the refractive index of the liquid crystal (e.g., via application of a voltage differential between the core and the outer shell) change the resonance properties of the coaxial resonant metamaterial structure.

Many of the examples described and illustrated herein utilize copper as an example conductive material that is suitable for many applications and operational bandwidths. Examples of conductive materials that may be suitable in various applications include copper, tin, gold, silver, titanium, aluminum, zinc, nickel, platinum, beryllium, rhodium, magnesium, iridium, and other elements, alloys, doped dielectrics, and combinations thereof. In some embodiments, as detailed below, a coaxial resonant metamaterial structure further includes an optical isolation structure that prevents (e.g., stops, eliminates, or at least reduces) optical radiation from passing through the coaxial resonant metamaterial structure via the liquid crystal in the ring-shaped cavity.

A metasurface may comprise many dynamically tunable resonant structures (e.g., coaxial resonant metamaterial structures) and a controller to selectively modify the resonance properties of each individual coaxial resonant metamaterial structure. In other embodiments, the controller may be used to selectively modify the resonance properties of groups or subsets of coaxial resonant metamaterial structures. The controller may identify a target pattern of surface currents that, when obtained by tuning the individual coaxial resonant metamaterial structures, results in a target field pattern within a region of space. The target field pattern may be chosen to manipulate (e.g., steer, attenuate, amplify, etc.) incident optical radiation.

In some embodiments, a coaxial resonant metamaterial structure may be thought of as a multilayer structure that includes a first resonant layer (e.g., with a conductive other shell, a ring-shaped cavity, and a conductive core) and a second, optical isolation layer. In some embodiments, the coaxial resonant metamaterial structure may include a third layer as a non-conductive substrate. in other embodiments, a coaxial resonant metamaterial structure may include a third layer as a conductive bias voltage layer to group a subset of coaxial resonant metamaterial structures for control purposes.

In various embodiments, the optical isolation layer may include a ring-shaped dielectric that at least partially overlaps the liquid crystal in the ring-shaped cavity. In some embodiments, the ring-shaped dielectric has a smaller radius than the ring-shaped cavity, such that a portion of the ring-shaped dielectric overlaps the conductive core, while another portion of the ring-shaped dielectric overlaps the liquid crystal in the ring-shaped cavity. In other embodiments, the ring-shaped dielectric has a larger radius than the ring-shaped cavity, such that a portion of the ring-shaped dielectric overlaps the conductive outer shell, while another portion of the ring-shaped dielectric overlaps the liquid crystal in the ring-shaped cavity.

As described herein, some metasurfaces may include an array or other arrangement of bicoaxial resonator metamaterial structures. A bicoaxial resonant metamaterial structure may include an outer conductive shell with an aperture formed therethrough that extends from a first surface of the outer conductive shell to a second, opposing surface of the outer conductive shell. A core may have a first radius that extends though the aperture from the first surface to the second, opposing surface. A first ring-shaped resonant cavity coaxial with respect to the core may have a first width and extend through the aperture and be filled with liquid crystal.

A ring-shaped conductor may extend through the aperture surrounding the first ring-shaped resonance cavity. The ring-shaped conductor may have a defined width and be coaxial with the core. A second, ring-shaped resonant cavity may extend through the aperture around the ring-shaped conductor with a width defined as the gap between the ring-shaped conductor and the walls of the aperture in the outer shell. The second ring-shaped resonant cavity may be filled with liquid crystal and be coaxial with the circular ring-shaped conductor. The resonance properties of each of the first and second ring-shaped resonant cavities may be individually tuned by application of different voltages to the core and the ring-shaped conductor.

Many existing computing systems, methods, and devices may be used in combination with the presently described systems and methods. Some of the infrastructure that can be used with embodiments disclosed herein is already available, such as general-purpose computers, computer programming tools and techniques, digital storage media, and communication links. A computing device or controller may include a processor, such as a microprocessor, a microcontroller, logic circuitry, or the like.

A processor may include a special-purpose processing device, such as application-specific integrated circuits (ASIC), programmable array logic (PAL), programmable logic array (PLA), programmable logic device (PLD), field programmable gate array (FPGA), or other customizable and/or programmable device. The computing device may also include a machine-readable storage device, such as non-volatile memory, static RAM, dynamic RAM, ROM, CD-ROM, disk, tape, magnetic, optical, flash memory, or other machine-readable storage medium. Various aspects of certain embodiments may be implemented using hardware, software, firmware, or a combination thereof.

The components of the disclosed embodiments, as generally described and illustrated in the figures herein, could be arranged and designed in a wide variety of different configurations. Furthermore, the features, structures, and operations associated with one embodiment may be applicable to or combined with the features, structures, or operations described in conjunction with another embodiment. In many instances, well-known structures, materials, or operations are not shown or described in detail to avoid obscuring aspects of this disclosure.

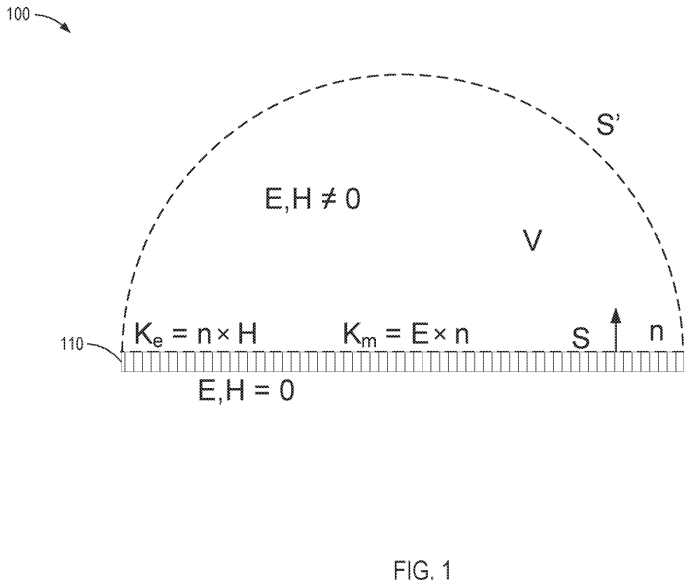

FIG. 1. illustrates a graphical depiction of the field equivalence principle, according to one embodiment. The presently described systems and methods utilize arrays of metamaterial elements that form a metasurface to control the electromagnetic fields within a region of space. This region of space is identified as V that is divided into a half space, with a boundary S and S′ extending to infinity. A metasurface 110 includes a one-dimensional or two-dimensional array of metamaterial coaxial elements, according to any of various embodiments described herein, is placed at the boundary S. The metasurface 110 generates some desired fields E in the volume V. The fields are discontinuous across S, but continuous across S′.

A target field within the region of space V satisfies the double-curl equation, expressed below as Equation 1.

∇×∇×E=k²E. Equation 1

Using the divergence theorem, the values of the field inside V are associated with an integral over the boundary. For points r∈V,

$$E = \frac{1}{ik} \int ( ( E \times n ) F + {Z}_{0} ( n \times H ) G ) d 𝒮 \qquad Equation 2$$

$$where$$

$$G = ( {k}^{2} I + ∇ ⊗ ∇ ) \frac{{e}^{ikr}}{4 π r} \qquad Equation 3$$

In Equation 3, G is the Green's tensor, which represents the electric field scattered by electric dipoles, and F is the magnetoelectric Green's tensor, which is the electric field scattered by magnetic dipoles, such that F=(1/ik)∇×G. A metasurface of metamaterial coaxial elements can be used to create a target field, E, via a distribution of electric and magnetic dipoles at the boundary S. Per Equation 2, this can be accomplished by placing magnetic surface currents Kₘ=E×n and electric surface currents Kₑ=n×H on S′.

Since the field is continuous across S′, but not across S, the surface currents only need to be generated on S′. Artificial surface currents can be generated by surface polarization that is related by, P=iωKₑ and M=iωμ₀Kₘ. The presently described systems and methods utilize metasurfaces to generate electric and magnetic dipoles that are sufficiently dense to generate electric and magnetic surface polarization to generate a target field within the region of space V that is continuous across S′.

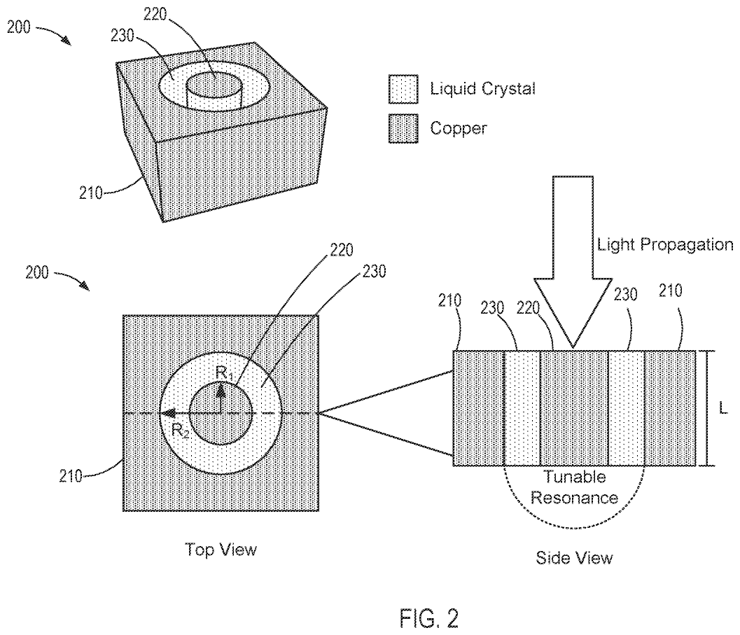

FIG. 2 illustrates various views of a coaxial resonator metamaterial element 200, according to one embodiment. As illustrated, a single metal layer 210 (e.g., copper) serves as an outer shell of the coaxial resonator metamaterial element 200 and has a thickness L. In the illustrated embodiment, a single concentric ring-shaped cavity is formed (e.g., cut) in the metal layer. The ring-shaped cavity is filled with liquid crystal 230 that separates the center of the ring (or core) 220 from the outer material of the metal layer 210. The inner circumference of the ring-shaped cavity filled with liquid crystal 230 has a radius R1, the radius of the core 220 is R1, and the outer circumference of the ring-shaped cavity filled with liquid crystal 230 has a radius R2

According to various embodiments, the ring-shaped cavity filled with liquid crystal 230 forms an optical resonator cavity, with a discrete set of resonance frequencies. As described below, the coaxial resonator metamaterial element 200 can be configured with dimensions to scatter as either an electric dipole or a magnetic dipole, depending on which mode resonates near the operating frequency. The magnetic and/or electric resonance (or resonances) of a coaxial resonator metamaterial element 200 can be tuned by applying a voltage to the liquid crystal 230 within the cavity.

In one example embodiment, the length L of the coaxial metamaterial element 200 is 400 nanometers, the inner radius R1 of the cavity (or radius of the core 220) is 50 nanometers, and the outer radius R2 of the cavity filled with liquid crystal 230 is 150 nanometers. In such an example, the amplitude of excitation, a, may be 580 nanometers.

In other embodiments, depending on the target operational frequency bandwidth, the length L of the coaxial metamaterial element 200 may be between 350 and 450 nanometers, the inner radius R1 of the core may be between 30 and 70 nanometers, and the outer radius R2 of the cavity filled with liquid crystal 230 may be between 100 nanometers and 200 nanometers. The amplitude of excitation, a, may be between 300 nanometers and 750 nanometers in various applications.

In other embodiments, the length L of the coaxial metamaterial element 200 may be between 50 and 500 nanometers. The combined cavity and core may have a radius or maximum distance from a center point to an outer edge between 25 and 250 nanometers. The core may fill a percentage of the cavity and be coaxial with the cavity. As an example, the cavity and core may be coaxial and the radius of the cavity may be twice as large as the radius of the core. In other embodiments, the ratio of the radius of the cavity and the core may vary between 0.01 and 0.99, such that the cavity is always large enough to accommodate the core.

In some embodiments, the cavity formed in the first conductive material may be cylindrical, elliptical, or polygonal. For example, the cavity may be formed as a polygonal prism having N sides, where N is an integer value.

Similarly, the second conductive material used to form the core (e.g., deposited in the cavity or left in place as the cavity is made in the first conductive material) may be circular, elliptical, or polygonal. For example, the second conductive material or “core” may be a polygonal prism having N sides, where N is an integer. In some embodiments, the cavity and the core are both polygonal, are coaxial, and have the same number of sides.

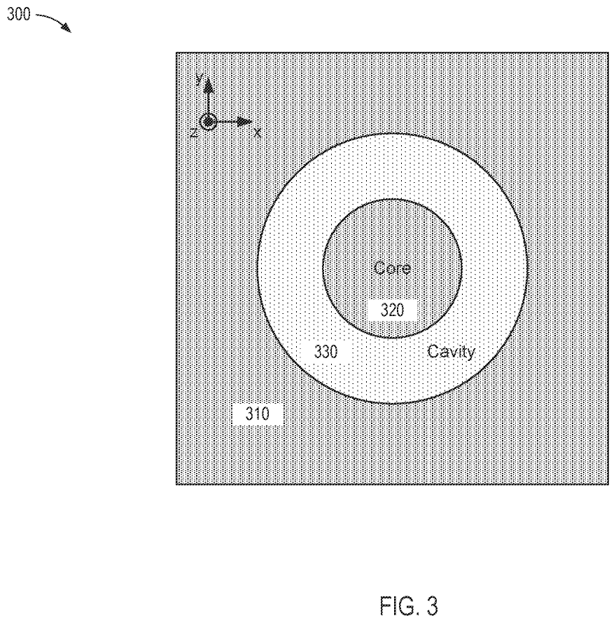

FIG. 3 illustrates a cross section of a circular coaxial resonant metamaterial element 300, according to one embodiment. As illustrated, the coaxial resonant metamaterial element 300 includes an outer shell 310, a cavity 330, and a core 320. It is appreciated that many homeomorphisms of the coaxial cavities exist that would exhibit similar properties and could be used in alternative embodiments and variations. For example, the cavity 330 is shown as circular, but could be an alternative shape.

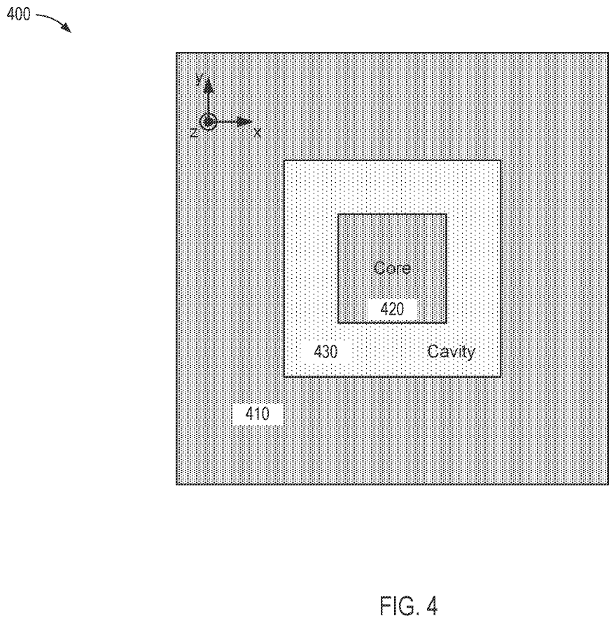

FIG. 4 illustrates one such example of a coaxial resonator metamaterial element 400 with an alternative cavity shape. Specifically, the illustrated coaxial resonator metamaterial element 400 has a rectangular cavity 430 formed within the outer metal shell layer 410 to define a rectangular core 420. The outer metal shell layer 410 and the rectangular core 420 form concentric or coaxial squares. Again, the cavity 430 can be defined as any of a wide variety of shapes so that the outer metal shell layer 410 and the core 420 are concentric, regardless of the specific shape.

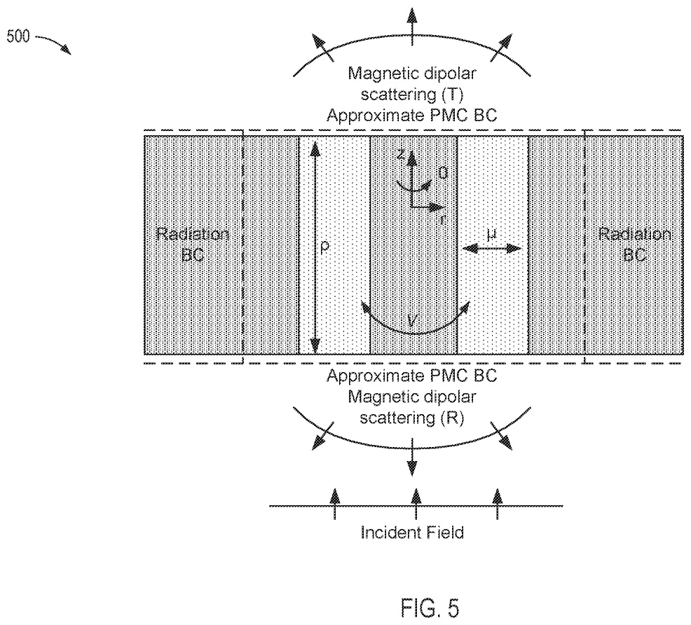

FIG. 5 illustrates a graphical illustration of magnetic dipolar scattering in a coaxial resonator metamaterial element 500, according to one embodiment. Quasinormal modes of the coaxial resonator formed by the coaxial resonator metamaterial element 500 can be found analytically with open ends of the coaxial cavity approximated as perfect magnetic condition (PMC) boundaries. The illustrated coaxial resonator metamaterial element 500 can be used in transmissive designs where optical radiation is passed through the metasurface.

The coaxial resonant metamaterial elements 300, 400, and 500 in FIGS. 3-5 radiate energy in both forwards and backwards directions. For in-reflection operation, forward scattering in the illustrated coaxial resonant metamaterial elements 300, 400, and 500 may scatter off materials beyond the element and result in undesired backscattering. For example, the backscattering may cause unwanted coupling with the coaxial resonant metamaterial elements 300, 400, and 500 that hinders controllability.

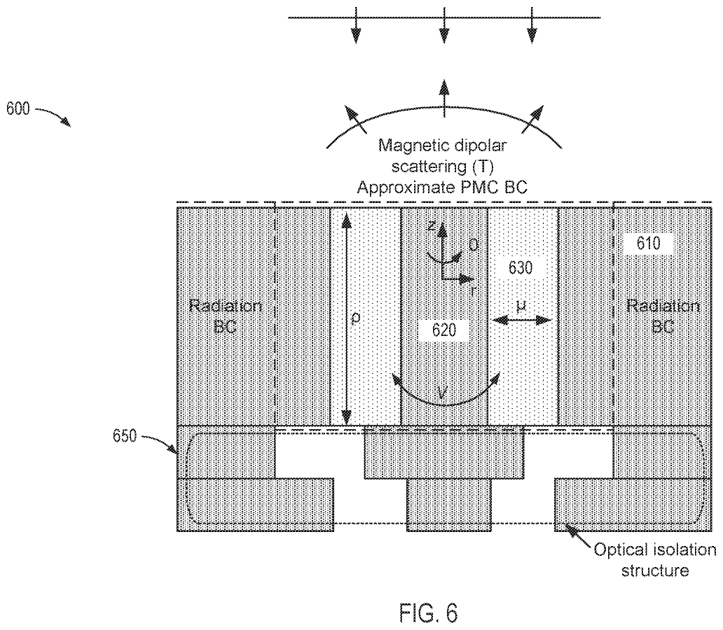

FIG. 6 illustrates a graphical illustration of magnetic dipolar scattering in a reflective coaxial resonator metamaterial element 600 with an optical isolation structure 650, according to one embodiment. The optical isolation structure 650 is the optical equivalent of a quarter wave impedance transformer to create an artificial perfect electrical condition boundary. The optical isolation structure 650 operates to cut or suppress coupling between a cavity mode and free space on one side of a cavity 630. The optical isolation structure 650 may reduce or eliminate unwanted backscattering.

Once cavity fields are known, coupling into and out of the cavity 630 can be found by applying Love's equivalence principles to solve for the electric and magnetic dipole moments of the quasinormal modes (QNMs). The scattering can be described as that of an anisotropic electric and/or magnetic dipole placed adjacent to a background metal layer 610. As previously described, the coaxial element 600 can be made tunable by filling the cavity 630 with liquid crystal, since the inner metal core 620 of the metamaterial element 600 is electrically isolated from the surrounding metal layer 610.

A controller can be used to apply a voltage between the inner metal core 620 and the surrounding metal layer 610, which rotates the liquid crystal 630. For example, the voltage bias may be a direct current (DC) voltage applied by a controller. The change in the anisotropic, dielectric tensor of the liquid crystal changes the resonance frequency of the cavity 630. Different voltage levels can be used to adjust the dielectric tensor of the liquid crystal. The changes to the resonance frequency of the cavity 630 change the optical scattering of the metamaterial element 600 at a given operating frequency.

Derivation for transverse-electric (TE) modes of the coaxial cavity 630 begins by applying the Helmholtz equation to the z-component of an electric field. One could also solve for transverse magnetic (TM) modes by beginning with the Helmholtz equation applied to the z-component of the electric field, but require at least one node in a radial direction, which typically places them beyond the frequency range of interest. For the transverse-electric (TE) modes, the H_{z} component follows Equation 4 below.

∇²H_{z}=−k²H_{z}Equation 4

In Equation 4, k=ω/c and represents the free space wavenumber. Equation 5 shows the z-component of the field separated.

H_{z}(r,θ,z)=R_{μv}(r)θᵥ(θ)Z_{ρ}(z) Equation 5

Equations 6, 7, and 8 show the variables separated with a Laplacian expressed in cylindrical coordinates.

$$\frac{{d}^{2} {Θ}_{v}}{d {θ}^{2}} = - {v}^{2} {Θ}_{v} \qquad Equation 6$$

$$r \frac{d}{dr} ( r \frac{{dR}_{μ v}}{dr} ) + [ {( {β}_{μ v} r )}^{2} - {v}^{2} ] {R}_{μ v} = 0 \qquad Equation 7$$

$$( {β}_{μ v}^{2} - \frac{{d}^{2}}{d {𝓏}^{2}} ) {Z}_{ρ} = ϵ {k}_{μ v ρ}^{2} {Z}_{ρ} \qquad Equation 8$$

The variables B_{μ} and v are constants of separation. These are three second-order ordinary differential equations, so there are two orthogonal solutions for each equation. When taken with boundary conditions they each become eigenvalue problems yielding a discrete set of eigenfunctions and eigenvalues.

The Θᵥ(θ) equation is solved first, which is a clear eigenvalue problem with eigenvalue v, which must be an integer because of the periodic boundary conditions on the polar coordinate. The solutions to the Θᵥ(θ) equation with eigenvalue v are an integer because of the periodic boundary conditions on the polar coordinate. The solutions are expressed as:

$$( {Θ}_{v} ( θ ) = \{ \begin{matrix}cos ( v θ ) \\ sin ( v θ )\end{matrix} \} \qquad Equation 9$$

The R_{μ}v equation may be solved taking v as a parameter, which when taken with boundary conditions in the radial direction is an eigenvalue problem yielding the radial wavenumber β_{μv} as the eigenvalue. The solutions are a linear superposition of the Hankel functions as:

$${R}_{μ v} ( r ) = \{ \begin{matrix}{H}_{v}^{( 2 )} ( {β}_{μ v} ( r ) ) \\ {H}_{v}^{( 1 )} ( {β}_{μ v} ( r ) )\end{matrix} \} \qquad Equation 10$$

The solutions together with the eigenvalue β_{μv} are determined by the boundary conditions in the radial direction. The Z_{μvp} equation may be solved together with the PMC boundary conditions to yield the solution:

Z_{ρ}(z)=cos(ρπz/L) Equation 11

In Equation 11, ρ is an integer and the eigenvalue of this equation is the resonance wavenumber, which yields the resonance frequency, k_{μvp}=ω_{μvp}/c. The resonance frequency is given by:

$${k}_{μ ν ρ} = \sqrt{\frac{{β}_{μ ν}^{2} + {( ρ π / L )}^{2}}{ϵ} .} \qquad Equation 12$$

By splitting the Laplacian operator into normal and planar components, expressing it in cylindrical coordinates, and then using the curl equations, one can express all of the components of the electric and magnetic fields solely in terms of derivatives of the z-components as:

$${E}_{r} = \frac{1}{{β}^{2}} [ \frac{{\partial }^{2} {E}_{z}}{\partial 𝓏 \partial r} - \frac{{ikZ}_{0}}{r} \frac{\partial {H}_{𝓏}}{\partial θ} ] \qquad Equation 13$$

$${E}_{θ} = \frac{1}{{β}^{2}} [ \frac{1}{r} \frac{{\partial }^{2} {E}_{z}}{\partial θ \partial 𝓏} + {ikZ}_{0} \frac{\partial {H}_{𝓏}}{\partial r} ]$$

$${H}_{r} = \frac{1}{{β}^{2}} [ \frac{ik ϵ}{{Z}_{0} r} \frac{\partial {E}_{z}}{\partial θ} + \frac{{\partial }^{2} {H}_{𝓏}}{\partial r \partial 𝓏} ]$$

$${H}_{θ} = \frac{1}{{β}^{2}} [ \frac{- ik ϵ}{{Z}_{0}} \frac{\partial {E}_{z}}{\partial r} + \frac{1}{r} \frac{{\partial }^{2} {H}_{𝓏}}{\partial θ \partial 𝓏} ]$$

In the case of the transverse electric modes, the expressions for the transverse components of the field reduce to:

$${E}_{r} = \frac{- {ikZ}_{0}}{{β}^{2} r} \frac{\partial {H}_{𝓏}}{\partial θ} \qquad Equation 14$$

$${E}_{θ} = \frac{{ikZ}_{0}}{{β}^{2}} \frac{\partial {H}_{𝓏}}{\partial r}$$

$${H}_{r} = \frac{1}{{β}^{2}} \frac{{\partial }^{2} {H}_{𝓏}}{\partial r \partial 𝓏}$$

$${H}_{θ} = \frac{1}{{β}^{2} r} \frac{{\partial }^{2} {H}_{𝓏}}{\partial θ \partial 𝓏}$$

Any individual eigenmode can be expressed within a coaxial resonator by substituting these sets of basis functions into the separation of variables product in Equation 5. The radial wavenumber β_{μv} is solved to determine the mode shape and resonance frequency, which is determined by the boundary conditions in the radial direction.

Scattering from quasi-normal modes of coaxial elements can be calculated using Love's field equivalence principles to represent the fields at the openings of the element as equivalent electrical surface currents (Kₑ=n×H) and magnetic surface currents (Kₘ=E×n), as described in conjunction with FIG. 1. Because of the approximate PMC boundary conditions on the openings to the coaxial element, Z_{μ} goes to zero at the openings, while its derivative approaches a maximum. The transverse component of the magnetic fields of the mode are zero at the openings, as is the electric surface current at the opening. The magnetic surface currents at the opening due to Eᵣ and E_{θ} determine the scattering.

The resulting magnetic surface current distribution can be expanded with the multipole expansion. The electric and magnetic dipole terms are:

$$m = \frac{1}{{ikZ}_{0}} \int {K}_{m} d 𝒮 \qquad Equation 15$$

$$p = \frac{{ϵ}_{0}}{2} \int ( r \times {K}_{m} ) d 𝒮 \qquad Equation 16$$

Equations 17 and 18 show the substitution of the expression for the magnetic surface current:

$$m = \frac{1}{{ikZ}_{0}} \int E \times nd 𝒮 \qquad Equation 17$$

$$p = \frac{{ϵ}_{0}}{2} \int ( ( r \cdot n ) E - ( r \cdot E ) n ) d 𝒮 \qquad Equation 18$$

The components of the dipole moments that are normal to the surface (denoted by the subscript “n”) can be separated from the component that is parallel to the surface (denoted by the subscript “t”), as expressed in Equations 19-22 below.

$${m}_{n} = 0 \qquad Equation 19$$

$${m}_{t} = \frac{1}{i k {Z}_{0}} \int E \times nd 𝒮 \qquad Equation 20$$

$${p}_{n} = \frac{- {ϵ}_{0}}{2} \int ( r \cdot E ) nd 𝒮 = 0 \qquad Equation 21$$

$${p}_{t} = \frac{{ϵ}_{0}}{2} \int ( r \cdot n ) Ed 𝒮 \qquad Equation 22$$

Per Equation 17, the magnetic dipole moment is in the plane of the surface. The electric dipole oriented normal to the surface could arise from a normal component of the electric field, but is zero for the set of transverse electric modes that are relevant to smaller gap sizes.

For the other components of the dipole moments, the electric field of the quasinormal modes is proportional to the expression in Equation 23 below:

$$E ∝ \hat{r} \frac{{R}_{μ ν} ( β r )}{β r} cos ( v θ ) {\partial }_{z} {Z}_{ρ} ( 𝓏 ) - \hat{θ} cos ( v θ ) {\partial }_{β r} {R}_{μ ν} ( β r ) {\partial }_{z} {Z}_{ρ} ( 𝓏 ) \qquad Equation 23$$

Selection rules can be determined using symmetry properties of the factors of the integrand, noting that any antisymmetric integrand results in a zero integral. Both \hat{r} and \hat{θ} are antisymmetric under reflections about the z-axis. The radial basis function R_{μv}(βr) is symmetric about the z-axis, as is Z_{ρ}(z). The angular basis function cos(vθ) is symmetric under reflections about the z-axis for even values of v, and antisymmetric for odd values of v. Putting this information together, the electric field E is symmetric about the z axis for odd values of v, and antisymmetric for even values of v. However, when it comes to reflections about the xy plane, it will be symmetric for even values of ρ and antisymmetric for odd values of ρ, ρ being the number of nodes in Z_{ρ}(z).

Per Equations 20 and 22, the coordinate vector, r, and the unit normal vector n, have relevant symmetry properties. Specifically, the coordinate vector, r, is completely antisymmetric, and the unit normal vector, n, is symmetric about the z-axis but antisymmetric when reflected about the xy plane. The surface integral in Equation 20 is zero when integrated on either side of the metal surface for even values of v, because the electric field is antisymmetric. When v is odd, the integral is zero for odd values of ρ, because the field is antisymmetric about the xy-plane, but the unit normal vector n is antisymmetric. The surface integral in Equation 21 is zero for the individual integrals on either side of the metal surface for odd values of v, since r is antisymmetric. When v is even, the integral is zero for odd values of ρ, since this causes the field to be antisymmetric about the xy-plane, but both r and n are antisymmetric.

Additionally, the surface integral in Equation 22 is zero for the individual integrals on either side of the metal surface when the field is antisymmetric (e.g., when v is even), since the inner product r·n is symmetric about the z axis. When v is odd, the integral is zero when ρ is odd. The gap size for practical designs is small enough that the set of modes can be restricted to those were μ=0.

A coaxial element in a metal layer can produce either electric or magnetic dipole moments, depending on which eigenmode dominates. A metasurface can include a sufficient number of coaxial metamaterial elements with subwavelength interelement spacing (e.g., subwavelength pitch). The individual coaxial metamaterial elements may be, for example, spaced at subwavelength intervals in a one-dimensional array or a two-dimensional array on a substrate or other insulating surface. The individual coaxial metamaterial elements can be individually tuned (or tuned in groups) by applying a voltage differential between each respective core 620 and outer layer 610. The metasurface can be controlled to generate a target field.

The amplitude of the quasinormal mode, a_{μ}, for a driving polarization P or magnetization M, is given by Equation 24:

$${a}_{μ} ( ω ) = \frac{{ω}^{2}}{{ω}_{μ}^{2} - {ω}^{2}} \frac{1}{{ℏω}_{μ}} \int ( {E}_{μ} \cdot P - {μ}_{0} {H}_{μ} \cdot M ) d V \qquad Equation 24$$

The amplitudes of the coaxial resonator quasinormal modes of a single coaxial metamaterial element when illuminated with an incident field can be calculated using a perturbative technique. The field driving the element can be approximated as the incident field in the absence of the coaxial element in the metal layer, which is the field of a plane wave reflecting off a metal. Using the Born approximation, the incident field can be assumed to be unperturbed by the introduction of the coaxial metamaterial element. The scattering of the incident field into the coaxial cavity can be described using Love's field equivalence principles, which represent the electric and magnetic incident fields on the openings to the coaxial cavity as electric and magnetic surface currents, which can be used to derive the amplitude of the excitation.

What is more immediately useful than to derive a precise expression for the polarizability is to demonstrate with these integrals which eigenmodes can be excited by an incident plane wave. This information shows which eigenmodes will scatter with which kind of dipole moment, and which will give which elements of the polarizability tensors will be zero or nonzero. The total transverse component of the magnetic field, Hₜ, is the incident field H_{0,t} plus the reflected field, where

Hₜ=(1−r)H_{0,t}≈2H_{0,t} Equation 25

Eₜ=(1+r)E_{0,t}≈0 Equation 26

In Equations 25 and 26, r is the transverse mode reflection coefficient, which approaches −1 in the perfect electrical conditions (PEC) limit of the metal. The surface current exciting the coaxial element can be expressed as:

Kₑ=(1−r)(n×H_{0,t}) Equation 27

The excitation of the quasinormal mode can, therefore, be expressed as:

$${a}_{μ} ( ω ) = \frac{{ω}^{2}}{{ω}_{μ}^{2} - {ω}^{2}} \frac{( 1 - r )}{ick {ℏω}_{μ}} \int {E}_{μ} \cdot ( n \times {H}_{0 , t} ) d 𝒮 \qquad Equation 28$$

Applying the scalar triple product, and factoring H_{0,t} out of the integral (since it is approximately constant across the surface of the coaxial element), the excitation of the quasinormal mode can be expressed as:

$${a}_{μ} ( ω ) = \frac{{ω}^{2}}{{ω}_{μ}^{2} - {ω}^{2}} \frac{( 1 - r ) {μ}_{0}}{{ℏω}_{μ}} {H}_{0 , t} \cdot {\int }_{{𝒮}_{-}} \frac{{E}_{μ} \times n}{{ikZ}_{0}} d 𝒮 \qquad Equation 29$$

The quantity in the integral of Equation 29 is identified using Equation 20, which is the magnetic dipole moment of the mode, except the integral is only over the bottom surface where the incident magnetic field is nonzero. This is half the magnetic dipole moment of the mode and therefore, can be expressed more simply as:

$${a}_{μ} ( ω ) = \frac{{ω}^{2}}{{ω}_{μ}^{2} - {ω}^{2}} \frac{( 1 - r ) {μ}_{0}}{2 {ℏω}_{μ}} {m}_{μ} \cdot {H}_{0 , t} \qquad Equation 30$$

As expressed above, the coaxial resonator metamaterial elements couple to the incident magnetic field, and not the incident electric field through the transverse magnetic dipole moment of the mode. Multiplying both sides of Equation 30 by the appropriate dipole moment for the mode yields the elements of the polarizability tensor that correspond to that mode. For instance, modes with odd v and odd p yields a magnetic transverse dipole moment. Since the incident field couples to the magnetic dipole moment of the mode, the modes, which have nonzero magnetic dipole moments, have nonzero magnetic polarizability. The tensorial magnetic polarizability resulting from a single mode is:

$${\overline{α}}_{m} = \frac{{ω}^{2}}{{ω}_{μ}^{2} - {ω}^{2}} \frac{( 1 - r ) {μ}_{0}}{2 {ℏω}_{μ}} {m}_{μ} ⊗ {m}_{μ} \qquad Equation 31$$

In Equation 31, m_{μ} is given by Equation 20 and lies in the XY-plane. Since the coaxial resonator metamaterial element is symmetric in the plane, the magnetic polarizability tensor is necessarily isotropic in the plane. This physically arises because every mode with mode number v has a degenerate mode that is given by the first mode but rotated by 90 degrees in the xy-plane, using the other basis element in Equation 9. Accordingly, the polarizability tensor can be written as:

$${\overline{α}}_{m} = [ \begin{matrix}{α}_{m} & 0 & 0 \\ 0 & {α}_{m} & 0 \\ 0 & 0 & 0\end{matrix} ] \qquad Equation 32$$

The scalar polarizability am is given by:

$${α}_{m} = \frac{{ω}^{2}}{{ω}_{μ}^{2} - {ω}^{2}} \frac{( 1 - r ) {μ}_{0} {m}_{μ} \cdot {m}_{μ}}{2 {ℏω}_{μ}} \qquad Equation 33$$

In some embodiments, the cavity is designed to have a mode with odd v and even ρ. In this case, the incident field still couples to the magnetic dipole moment, but results in scattering like an electric dipole moment. A structure which scatters like an electric dipole in response to an incident magnetic field is bianisotropic. In the case of the coaxial element in a metal layer, the incident magnetic field is only able to couple to one side of the coaxial resonator metamaterial element. If the incident field is on both sides of the metal layer, the magnetic field couples to both sides, but with opposite sign, and no excitation of the electric dipole moment occurs. However, with only one side illuminated, the magnetic field is able to excite the electric dipolar resonance.

For modes with even ρ and odd v, the magnetic polarizability has negative coupling, while the magnetic polarizability has positive coupling for modes with odd ρ and odd v. Under the circumstances of a coaxial resonator where a mode of even ρ dominates the scattering, the scattering can be described as bianisotropy, using bianisotropic polarizability tensor. This tensor can be determined by multiplying both sides of Equation 30 by the electric dipole moment of the mode, such that that tensor αₑₘ can be expressed as:

$${\overline{α}}_{em} = \frac{{ω}^{2}}{{ω}_{μ}^{2} - {ω}^{2}} \frac{( 1 - r ) {μ}_{0}}{2 {ℏω}_{μ}} {p}_{μ} ⊗ {m}_{μ} \qquad Equation 34$$

The electric dipole moment of the resonance is perpendicular to the magnetic dipole moment of the resonance. The bianisotropic polarizability tensor must also be antisymmetric, and therefore takes the form:

$${\overline{α}}_{em} = [ \begin{matrix}0 & {α}_{em} & 0 \\ - {α}_{em} & 0 & 0 \\ 0 & 0 & 0\end{matrix} ] \qquad Equation 35$$

The scalar bianisotropic polarizability is expressible as:

$${α}_{em} = \frac{{ω}^{2}}{{ω}_{μ}^{2} - {ω}^{2}} \frac{( 1 - r ) {μ}_{0}}{2 {ℏω}_{μ}} {p}_{μ} \cdot ( n \times {m}_{μ} ) \qquad Equation 36$$

The components of the bianisotropic polarizability tensor involving the z direction are zero, because modes which scatter as an electric dipole in the z direction require even v, which have zero magnetic dipole moments and therefore cannot couple to the incident magnetic field. Since the incident field only couples to the magnetic dipole moment due to the approximate perfect electrical condition boundary of the metal layer, the electric polarizability tensor is approximately zero.

While the scattering from individual, subwavelength metamaterial elements can be described by the electric and magnetic dipole moments, the field scattered by periodic arrays of metamaterial elements is likewise periodic. The periodic solutions of Maxwell's equations are plane waves and define the set of free space modes. The scattering parameters for a single coaxial resonator metamaterial element operating in transmission are calculated for each mode that is used for an operational frequency.

Secondly, although the polarizability can, in principle, be derived analytically using quasi-normal mode theory, a transverse-electric (TE) polarized wave with a k-vector may illuminate a metasurface with a plurality of single coaxial resonator metasurface elements (e.g., an array of single coaxial resonator metasurface elements). On the metasurface, which lies at the z=0 plane, the incident electric field can be expressed as:

E=ŷ(1+r)E₀e^{-ik}^{ₓ}^{x} Equation 37

In Equation 37, r is the Fresnel transverse electric reflection coefficient. The elements are excited by the incident magnetic field as:

$${H}_{x} = \frac{- {k}_{z} ( 1 - r ) {E}_{0}}{{kZ}_{0}} {e}^{- {ik}_{x} x} \qquad Equation 38$$

$${H}_{z} = \frac{- {k}_{x} ( 1 - r ) {E}_{0}}{{kZ}_{0}} {e}^{- {ik}_{x} x} \qquad Equation 39$$

Again, since the reflection coefficient is nearly −1 for a metal, the only significant component of the field is Hₓ, which is also the component that excites the magnetic or electric dipole moment of the single coaxial element. The incident fields, together with the magnetic and magneto-electric polarizabilities, yield the dipole moments. The last piece of information that is required is the electric field radiated by the electric and magnetic dipole moments of the elements. For a periodic array of electric dipoles separated by inter-element spacing α and with a dipole moment p=p_{y}ŷ, the y-component of the radiated electric field is expressible as:

$${E}_{y} = \frac{- {ik}^{2}}{2 {a}^{2} {k}_{x}} \frac{{p}_{y}}{{ϵ}_{0}} {e}^{- i ( {k}_{x} x + {k}_{z} \vert z \vert )} \qquad Equation 40$$

For a periodic array of magnetic dipoles, with magnetic dipole moment m=mₓ\hat{x}, the y-component of the radiated electric field is expressible as:

$${E}_{y} = \frac{- {ik}^{2}}{2 {a}^{2}} {Z}_{0} {m}_{x} sgn ( z ) {e}^{- i ( {k}_{x} x + {k}_{z} \vert z \vert )} \qquad Equation 41$$

Equations 40 and 41, together with the illuminating field described in Equation 38 and the definitions of the polarizabilities, yield the scattering parameters:

$${S}_{21} = \frac{i ( 1 - r ) {k}_{z}}{2 {a}^{2}} ( \frac{k}{{k}_{z}} c {α}_{em} - {α}_{m} ) \qquad Equation 42$$

$${S}_{11} = \frac{i ( 1 - r ) {k}_{z}}{2 {a}^{2}} ( \frac{k}{{k}_{z}} c {α}_{em} - {α}_{m} ) - r \qquad Equation 43$$

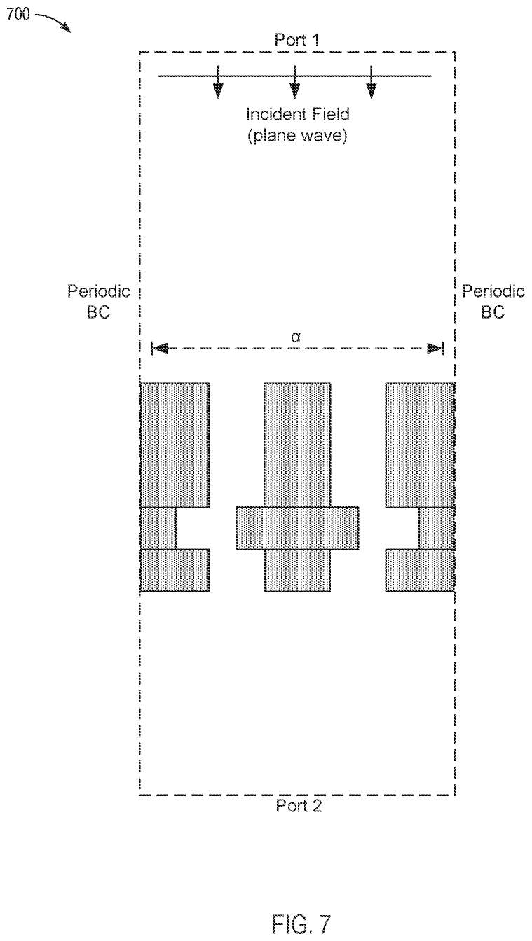

FIG. 7 illustrates a full-wave simulation boundary condition of a coaxial resonator metamaterial element 700 for polarizability extraction using scattering parameters, according to one embodiment. The scattering parameters can be calculated from the ports in the full wave simulation. To extract the polarizabilities from full wave simulations, the equations can be inverted to find the polarizabilities in terms of the scattering parameters:

$${α}_{em} = \frac{- {ia}^{2}}{( 1 - r ) ck} ( {S}_{11} + {S}_{21} + r ) \qquad Equation 44$$

$${α}_{m} = \frac{- {ia}^{2}}{( 1 - r ) {k}_{z}} ( {S}_{11} + {S}_{21} + r ) \qquad Equation 45$$

The coaxial resonator metamaterial elements are tuned by changing their resonance frequency. Specifically, a voltage differential is applied across liquid crystal within the resonator cavity. A tensorial refractive index can be written as:

n̅_{LC}=Δn\hat{n}Ø\hat{n}+Inₒ Equation 46

In Equation 46, \hat{n} is the liquid crystal director, a unit vector that describes the orientation of the extraordinary optic axis, and Δn=nₑ−nₒ is the difference between the refractive index parallel to the director of the liquid crystal, minus the refractive index perpendicular thereto. The eigenvalues nₒ and nₑ can be alternatively referred to as the ordinary and extraordinary refractive indices of the liquid crystal. The anisotropic dielectric tensor of liquid crystal is a result of anisotropic polarizability tensors characteristic of liquid crystal molecules, rather than due to an anisotropy in the lattice structure.

In its relaxed state, liquid crystal tends to orient its refractive index parallel to the surface that it is placed on. In the cavity of a coaxial resonator metamaterial element 700, the liquid crystal aligns parallel to the surfaces of the cavity in the relaxed state (e.g., in the z-direction). However, because the liquid crystal molecules are strongly anisotropic in their polarizability at low frequencies, liquid crystal can be rotated in the presence of a quasi-static electric field due to the force the field exerts on the polarized dipole moments in the molecules.

In some embodiments, a positive voltage V is placed on the central metal core of the coaxial resonator metamaterial element, while the outside metal layer is grounded. By Gauss's law, the field in the coaxial resonator metamaterial element is expressible as:

$${E}_{D C} = \frac{V}{ln ( {R}_{2} / {R}_{1} ) r} \hat{r} \qquad Equation 47$$

The corresponding capacitance C is expressible as:

$$C = \frac{2 {πϵ}_{0} L}{ln ( {R}_{2} / {R}_{1} )} \qquad Equation 48$$

The torque exerted by the electric field on the liquid crystal can be found from Maxwell's stress tensor,

T=EØD+H⊗B−½(E·D+H·B)I Equation 49

The torque density, T, from the electromagnetic field, is given by the antisymmetric portion of the stress tensor T=εᵢⱼₖTⱼₖ:

[symbol]

=E×D Equation 50

Using D=εE and ε=n²_{LC}, the torque density can be expressed in terms of the liquid crystal director as:

[symbol]

=ϵ₀Δϵ(E·n)(n×E) Equation 51

In Equation 51, Δϵ=n_{ϵ}²−nₒ².

The electromagnetic torque on the liquid crystal within the cavity balances the internal mechanical torques of the liquid crystal due to its rotation, per application of Noether's theorem. However, it can be seen in Equation 51 that, given sufficient voltage applied to the core of the coaxial resonator metamaterial element, the liquid crystal will rotate until the torque vanishes, which occurs when the liquid crystal is parallel to the applied electric field (i.e., in the radial direction).

When liquid crystal is added to the cavity, the fundamental resonance of the cavity changes as a function of the orientation of the liquid crystal. The liquid crystal gives rise to a volumetric polarization P=ϵ₀χE when it is excited by the electric field in the cavity, which will be dominated by the mode of interest, (i.e., E≈a_{μ}E_{μ}), such that:

$${ω}_{μ} - ω - \frac{{ω}^{2}}{2 {ℏω}_{μ}^{2}} \int {E}_{μ} χ {E}_{μ} dV = 0 \qquad Equation 52$$

In Equation 52, the susceptibility tensor is given by:

χ=ΔχnØn+χ₀I Equation 53

In Equation 53, Δχ=Δϵ=nₑ²−nₒ², χ₀=n₀²−1.

The complex frequency, ω, that satisfies Equation 52 is the resonance frequency of the cavity filled with liquid crystal. For sufficiently small perturbations, the resonance frequency shift is given by:

Δω_{μ}=−g_{μ}Δχ. Equation 54

In Equation 54, the coupling constant between the cavity and the liquid crystal, given in units of angular frequency, is expressible as:

$${g}_{μ} = \frac{1}{2 ℏ} \int {E}_{μ} χ {E}_{μ} dV \qquad Equation 55$$

For lossless cavities, the quasinormal magnetic fields E_{μ} are real. When losses are included, the quasinormal magnetic fields are perturbatively complex inside the cavity, and the quasinormal magnetic fields are still well-confined. Accordingly, per Equation 54, the resonance frequency decreases as the voltage applied to the cavity is increased. However, given the complex nature of the true quasinormal magnetic fields, a change in quality factor may occur as the liquid crystal is rotated.

According to various embodiments, the liquid crystal susceptibility tensor of the coaxial resonator metamaterial element may be approximated as a scalar. Since the modes are transverse electric and the liquid crystal director is never oriented in the azimuthal direction by symmetry, according to Equation 54, the resonance frequency shift is dependent on the radial component of the liquid crystal susceptibility tensor. Moreover, for modes with a mode number of zero in the radial direction (e.g., for relatively small R2-R1), the derivative H_{z} with respect to the radial direction is approximately zero. Accordingly, the electric field is dominated by the radial component and the resonance frequency shift is insensitive to the change in liquid crystal refractive index in the azimuthal, or z-directions. Therefore, we can approximate the liquid crystal susceptibility tensor as a scalar that starts at 1 and increases as the applied voltage is increased.

According to various embodiments, as described above, a coaxial resonator metamaterial element can be used to generate either an electric or magnetic surface current, depending on which eigenmode is tuned to the operating frequency of interest. The amplitude and phase of the polarizability will follow that of a Lorentzian oscillator. In various embodiments, a metasurface includes a plurality of coaxial resonator metamaterial elements arranged or aggregated into a periodic arrangement. The resulting metasurface (or pixel) is characterized by its reflection and transmission coefficients, which are related to the polarizabilities.

As described above, the liquid crystal within the cavity of a coaxial resonator metamaterial element rotates from a rest orientation when a bias voltage differential is applied between the core and the outer material. The rotation of the liquid crystal changes the resonance frequency of the quasinormal mode. The phase and amplitude of the polarizability of each individual coaxial resonator metamaterial element can be controlled to individually tune the reflection and transmission coefficients.

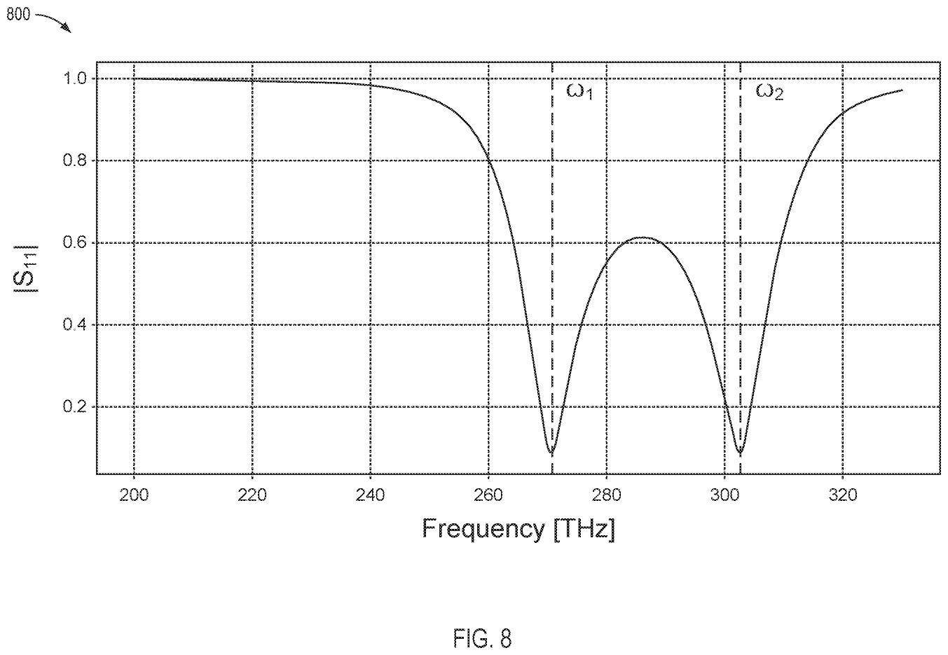

FIG. 8 illustrates a graph 800 of a reflectance spectrum of a metasurface formed as an array or other arrangement of coaxial resonator metamaterial elements with subwavelength interelement spacings, according to one embodiment. As illustrated, a range of scattering parameters are achievable by tuning the resonance frequency of each coaxial resonator metamaterial element in a metasurface of coaxial resonator metamaterial elements. The graph 800 pertains to an example embodiment of coaxial resonant metamaterial elements that each have a length L of 400 nanometers, an inner cavity or core radius of 50 nanometers, and an outer cavity radius of 150 nanometers. The cavity of each coaxial resonator metamaterial element is filled with liquid crystal and a voltage controller is used to selectively apply a voltage differential between the core and the outer material of each coaxial resonator metamaterial element or groups, sets, or subsets of coaxial resonator metamaterial elements.

For the graph 800, the value of a is 580 nanometers, periodic boundary conditions are used in the x and y dimensions, and ports are established at the limits of the z axis for the simulation. The metasurface of coaxial resonator metamaterial elements is illuminated with a plane wave, and the reflection and transmission coefficients are monitored. The graph 800 illustrates the reflectance spectrum of a single coaxial resonator metamaterial element with the liquid crystal index set to 1.5. In the illustrated embodiment, the reflectance spectrum of the metasurface of coaxial resonator metamaterial elements shows resonances at ω₁ and ω₂.

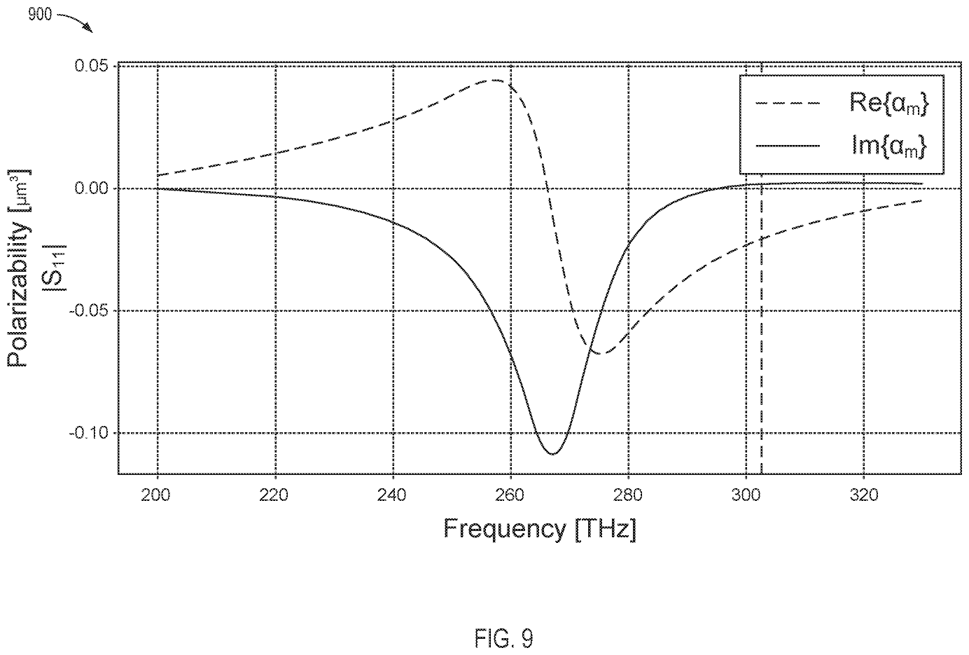

FIG. 9 illustrates a graph 900 of the extracted magnetic polarizability of a single coaxial resonator metamaterial element, according to one embodiment. The resonances can be identified using Equations 44 and 45 above. The extracted polarizabilities show a single classic Lorentzian resonance for each polarizability, at the frequencies ω₁ and ω₂. The imaginary component of the polarizability is negative as is required by conservation of energy, and the real part shows an asymmetric Lorentzian behavior around the resonance frequency, as predicted using Equations 33 and 35 above using the quasinormal magnetic theory characterization of the polarizabilities.

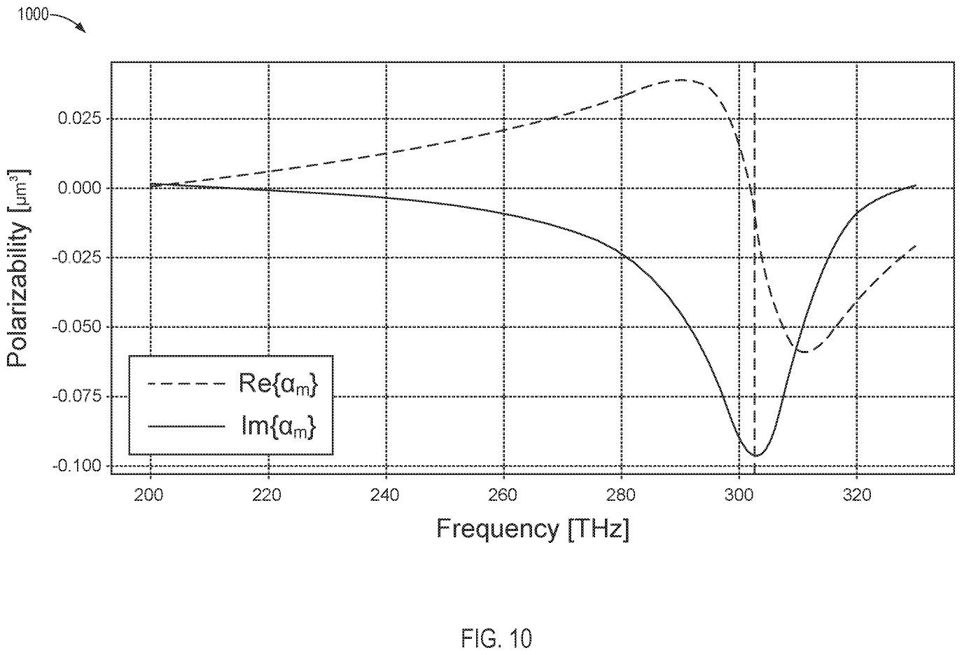

FIG. 10 illustrates a graph 1000 of the extracted electromagnetic polarizability of a single coaxial resonator metamaterial element, according to one embodiment. As illustrated and predicted using the equations above, the quasinormal mode has mode number (μ,v,ρ)=(0,1,0) at ω₁, while the QNM has mode numbers (μ,v,p)=(0,1,1) and at ω₂. These are the most fundamental modes that can be excited by an external plane wave, since modes with v=0 cannot couple to an incident quasistatic field because they have the wrong symmetry. This is fundamentally different when a voltage is applied to the core of a coaxial resonator metamaterial element rather than an externally incident plane wave, since the source now has the correct symmetry to excite v=0 modes, and the static mode (μ,v,p)=(0,0,0) in particular.

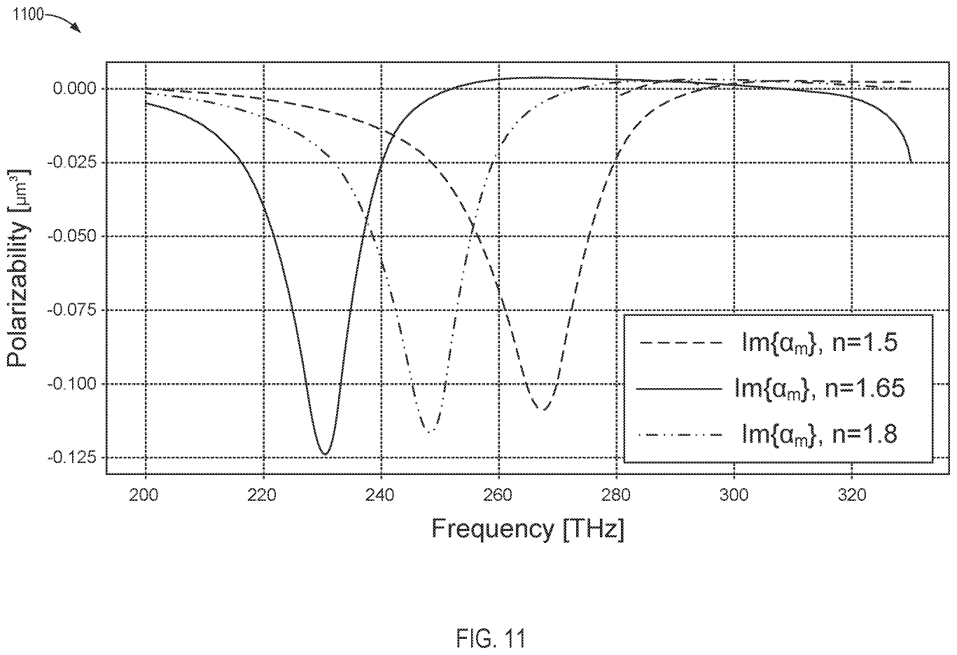

FIG. 11 illustrates a graph 1100 of an imaginary part of a magnetic polarizability of a single coaxial resonator metamaterial element as the liquid crystal refractive index n is varied, according to one embodiment. When this voltage is applied, it rotates the liquid crystal, changing the effective refractive index that the fields are exposed to in the cavity, as described herein. As illustrated in graph 1100 of the imaginary parts of the resulting magnetic polarizability, the resonance shifts to lower frequencies as the liquid crystal refractive index is increased, as specified in Equation 54 above.

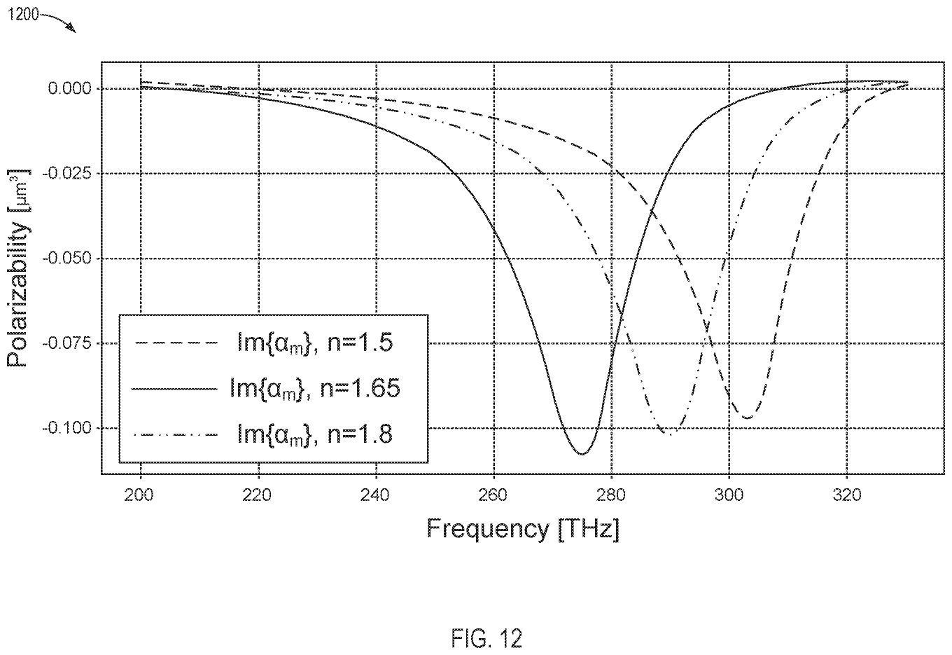

FIG. 12 illustrates a graph 1200 of an imaginary part of a bianisotropic polarizability of a single coaxial resonator metamaterial element with respect to a variable liquid crystal refractive index, according to one embodiment. The graph 1200 of the bianisotropic parts of the polarizability also show that the resonance shifts to lower frequencies for both types of polarizability as the refractive index of the liquid crystal is increased.

According to various embodiments, as illustrated by the graphs 800, 900, 1000, 1100, and 1200 in FIGS. 8-12, the coaxial resonator metamaterial element can be configured with a resonance in its magnetic polarizability at one frequency, and a resonance in its bianisotropic polarizability at another frequency. Both of these resonance frequencies can be tuned as a DC voltage is applied to rotate the liquid crystal within the cavity.

According to various embodiments, a coaxial resonator metamaterial element can be configured to generate target fields in a domain at a single frequency (or narrow band of frequencies). As described above, the coaxial resonator metamaterial element can be configured with dimensions and applied voltages to construct a magnetic surface current having a target amplitude and phase with respect to an illuminating beam. Given an operating frequency, a range of polarizabilities are achievable to manipulate the planar wave.

As a specific example, a coaxial resonator metamaterial element can be configured to have an operating frequency with a center tuning of approximately 248 THz. At this frequency, the polarizability can be extracted from full wave simulations using Equations 44 and 45, as the liquid crystal refractive index is varied. Since the polarizability is a complex number, and the liquid crystal refractive index is a real number, the polarizability is a curve in the complex plane that can be parameterized by the liquid crystal refractive index. Per Equation 54, the resonance frequency shift is linear in Δχ, which ranges from zero to nₑ²−n₀² as the liquid crystal director is rotated. For this range of liquid crystal refractive indices, the cavity coupling parameters for the two resonances are g₁=2π·30 THz and g₂=2π·37 THz.

The cavity coupling parameters can be expressed as static polarizabilities with a quality factor and an x-dependent resonance frequency as:

$${α}_{m} = \frac{{ω}_{1}^{2} {α}_{m 0}}{{( {ω}_{1} - Δχ {g}_{1} )}^{2} ( 1 + i / Q ) - {ω}^{2}} \qquad Equation 56$$

$${α}_{em} = \frac{{ω}_{2}^{2} {α}_{em 0}}{{( {ω}_{2} - Δχ {g}_{2} )}^{2} ( 1 + i / Q ) - {ω}^{2}} \qquad Equation 57$$

The static polarizabilities in Equations 56 and 57 are real numbers, since their normal imaginary parts that result from the radiation reaction force are incorporated into the quality factor.

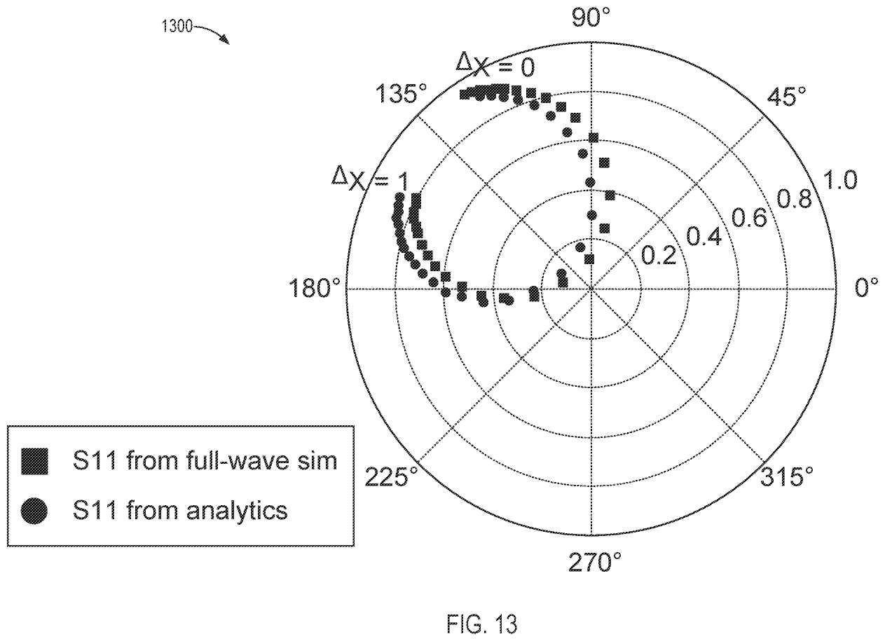

The polarizabilities in Equations 56 and 57 have three unknowns. The parameters that fit the symmetrical geometry are: αₘ₀=αₑₘ₀=0.0017 μm³, Q₁=Q₂=17, g₁=2π·30 THz, and g₂=2π·37 THz. Moreover, the scattering parameters can be predicted at any operating frequency ω as the liquid crystal is tuned, for some assumed values of static polarizability and quality factor, as illustrated in FIG. 13-16.

FIG. 13 illustrates a polar graph 1300 of a complex valued reflection coefficient of a metasurface of an arrangement of coaxial resonator metamaterial elements, according to one embodiment. The polar graph 1300 shows the complex valued reflection coefficient, S₁₁, of a metasurface with coaxial resonant metamaterial elements at the center of the tuning range of the magnetic polarizability resonance, f₁=ω₁/2π=250 THz, as the LC index is tuned.

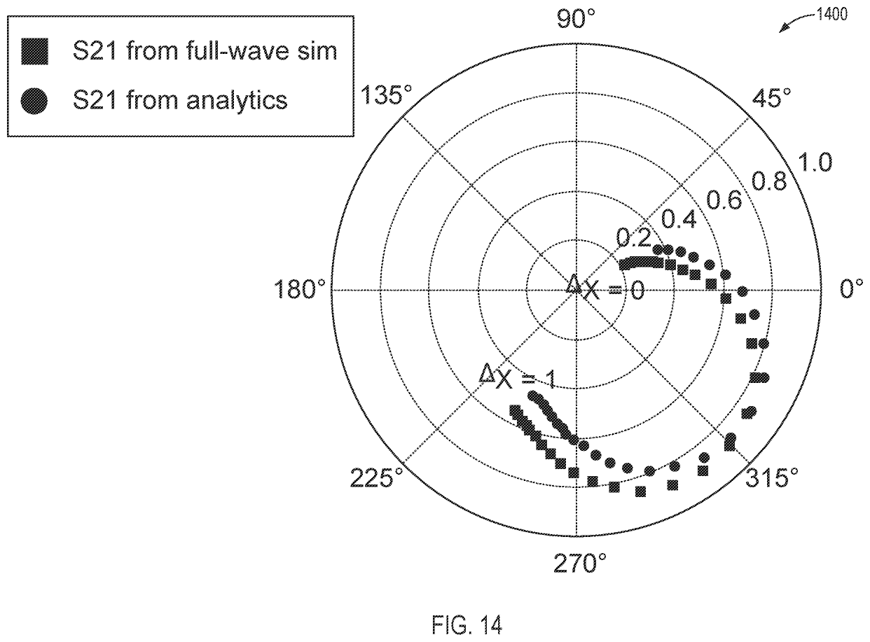

FIG. 14 illustrates a polar graph 1400 of a complex valued transmission coefficient of a metasurface of coaxial resonator metamaterial elements, according to one embodiment. The polar graph 1400 shows the complex valued transmission coefficient, S₂₁, of a metasurface with coaxial resonant metamaterial elements at the center of the tuning range of the magnetic polarizability resonance, f₁=ω₁/2π=250 THz, as the LC index is tuned.

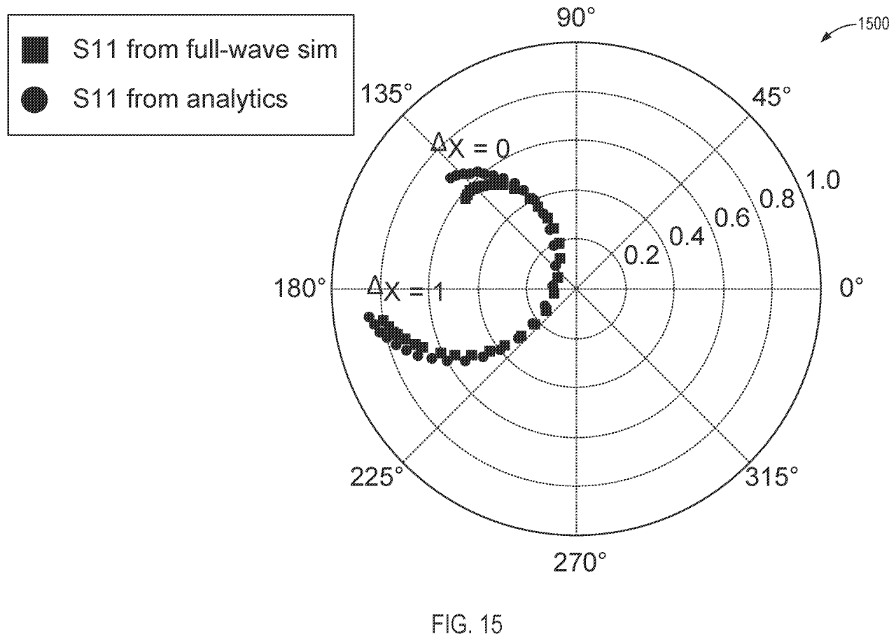

FIG. 15 illustrates another polar graph 1500 of a complex valued reflection coefficient of a metasurface of coaxial resonator metamaterial elements, according to one embodiment. The polar graph 1500 shows complex valued reflection coefficient, S₁₁, of a metasurface with coaxial resonant metamaterial elements at the center of the tuning range of the bianisotropic polarizability resonance, f₂=ω₂/2π=290 THz, as the LC index is tuned.

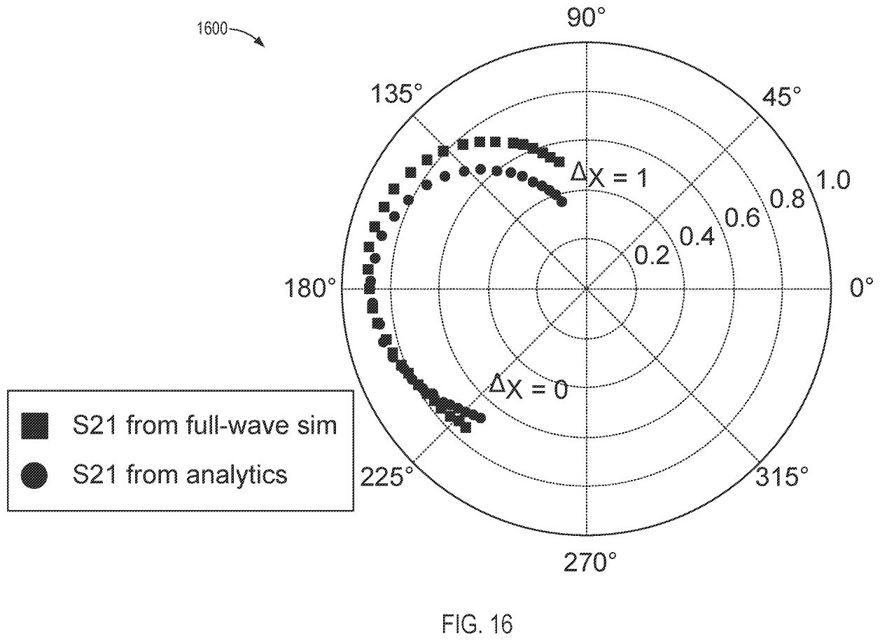

FIG. 16 illustrates another polar graph 1600 of a complex valued transmission coefficient of a metasurface of coaxial resonator metamaterial elements, according to one embodiment. The polar graph 1600 shows complex valued transmission coefficient, S₂₁, of a metasurface with coaxial resonant metamaterial elements at the center of the tuning range of the bianisotropic polarizability resonance, f₂=ω₂/2π=290 THz, as the LC index is tuned.

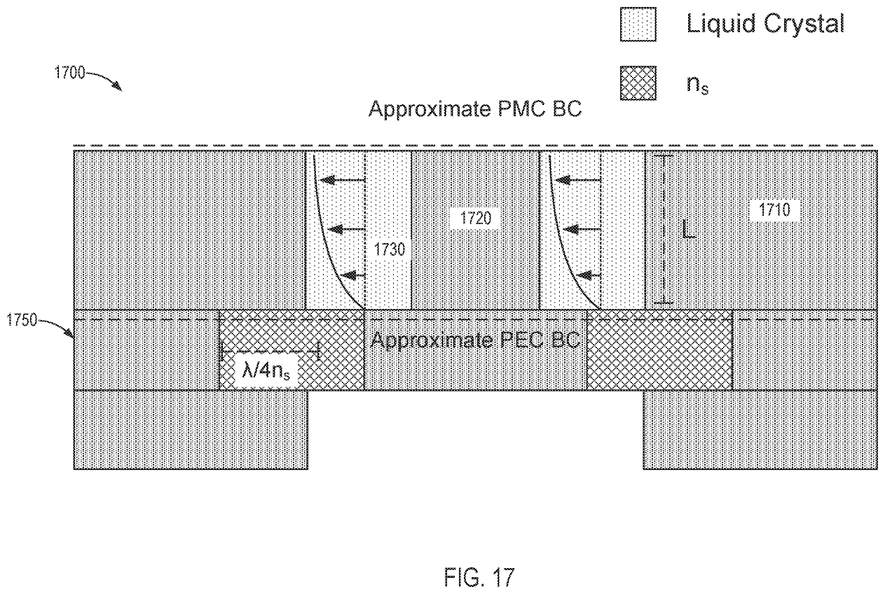

FIG. 17 illustrates a cut-away view of a block diagram of a circular or rectangular receive coaxial resonator metamaterial element 1700 with an optical isolation structure 1750, according to one embodiment. For in-reflection operation, forward scattering is stopped by the optical isolation structure 1750 to reduce or eliminate backscattering. As illustrated, the coaxial resonator metamaterial element 1700 includes an outer layer of metal 1710, a cavity 1730 filled with liquid crystal, and a core 1720 of metal. As previously described, a voltage differential can be applied between the core 1720 and the outer layer of metal 1710 to cause the liquid crystal to rotate within the cavity 1730 for tuning purposes.

In the illustrated embodiment, the optical isolation structure 1750 is configured to prevent any forward scattering through the coaxial resonator metamaterial element 1700, which results in an artificial perfect electrical condition (PEC) boundary. This type of coaxial resonator metamaterial element 1700 may be referred to as a receive or Rx coaxial resonator metamaterial element.

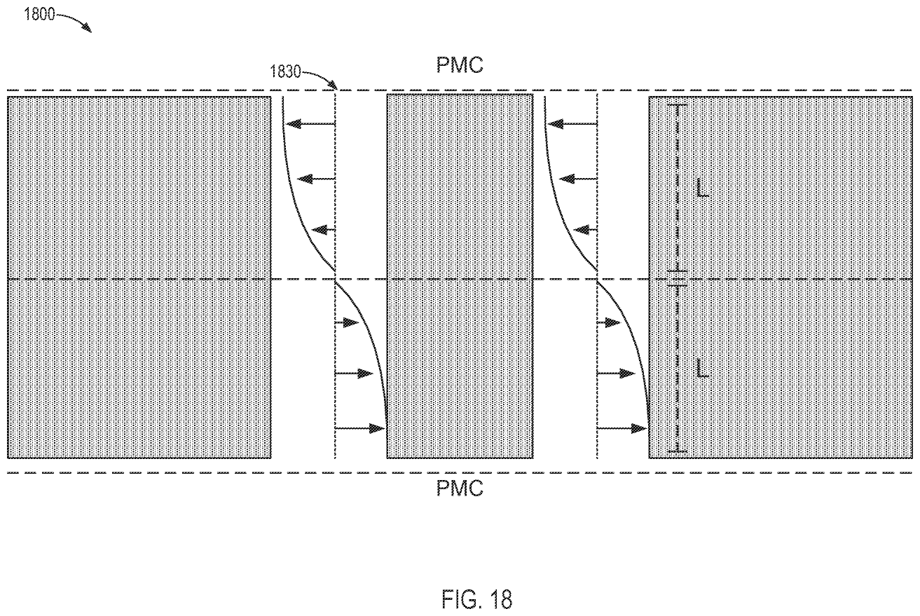

FIG. 18 illustrates a block diagram 1800 of electromagnetic equivalence with the coaxial resonator metamaterial element of FIG. 17, according to one embodiment. As illustrated, a coaxial cavity 1830 with a PEC boundary condition on a bottom surface and a PMC boundary condition on an upper surface, is equivalent to a coaxial cavity 1830 of twice its length with PMC boundary conditions on both sides. Because the field is inverted halfway through the cavity 1830, the field must go to zero at the center (to be consistent with the PEC boundary condition) which restricts the cavity 1830 to only supporting modes that are odd in ρ. Additionally, because the element is isotropic in the plane and has zero magnetic dipole moment parallel to the optic axis, the magnetic polarizability tensor and matrix elements can be calculated using Equations 31-33, and the reflection coefficient will be:

$${S}_{11} = \frac{{i ( 1 - r )}^{2} {k}_{z}}{2 {a}^{2}} {α}_{m} - r \qquad Equation 58$$

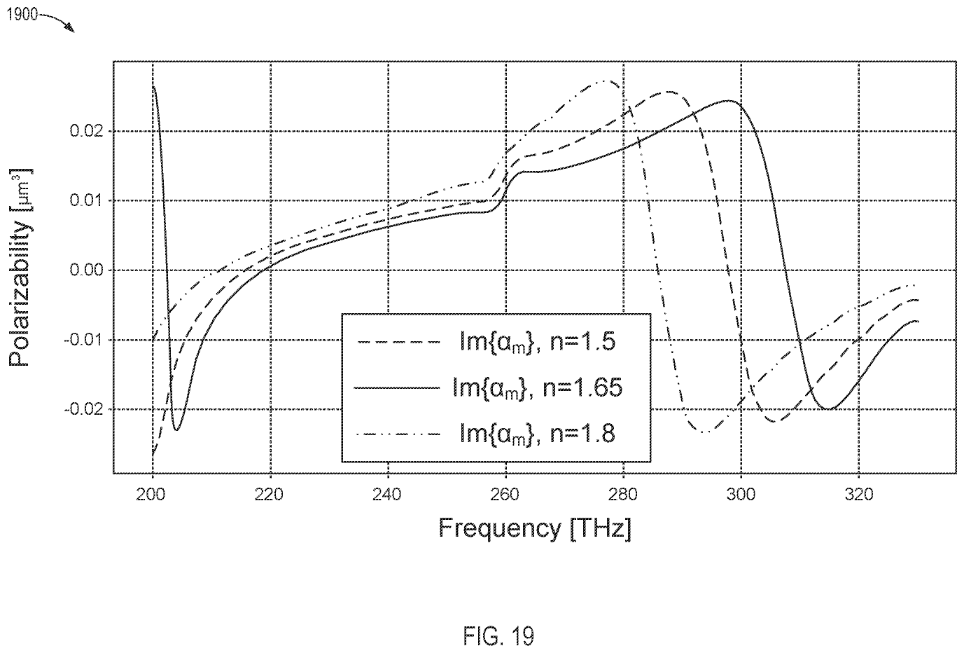

FIG. 19 illustrates a graph 1900 of the real part of the polarizability showing a linear shift in resonance frequency as a function of liquid crystal refractive index, according to one embodiment.

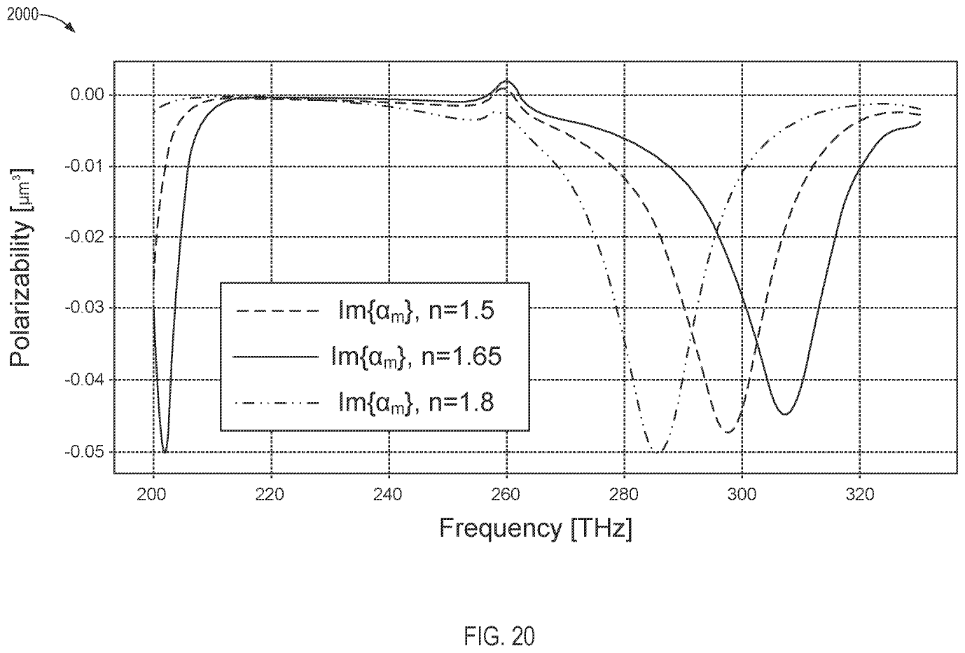

FIG. 20 illustrates a graph 2000 of the imaginary part of the polarizability showing a linear shift in the resonance frequency as a function of liquid crystal refractive index, according to one embodiment. Together, FIGS. 19 and 20 show the real and imaginary parts of the extracted magnetic polarizability with the refractive index of the liquid crystal at 1.5, 1.65, and 1.8. A coaxial resonator metamaterial element with a length L of 200 nm results in approximately the same resonance frequency for the in-reflection single coax as the ω₂ resonance of the in-transmission single coaxial resonator, with all other parameters being equal.

Furthermore, the graph 2000 illustrates the linear relationship between the resonance frequency shift and the change in liquid crystal susceptibility, as described by g=2π·30 THz. Using the classic Lorentzian description of the magnetic polarizability resonance, the static polarizability and quality factor can be fit as αₘ₀=0.0034 μm³, Q=15, and g=2π·30 THz.

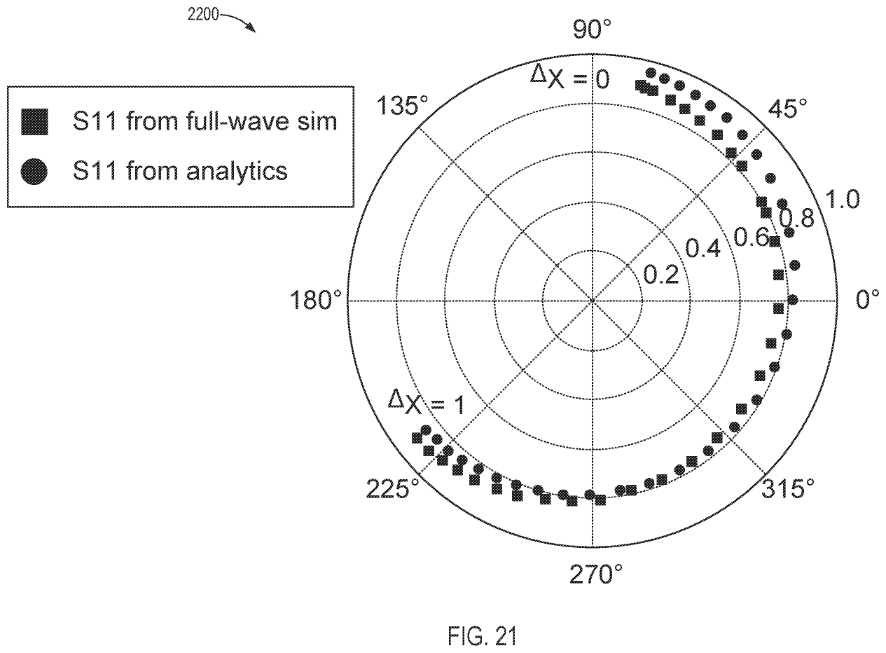

FIG. 21 illustrates a polar graph 2100 of the complex value optical isolation performance, S₁₁, according to one embodiment.

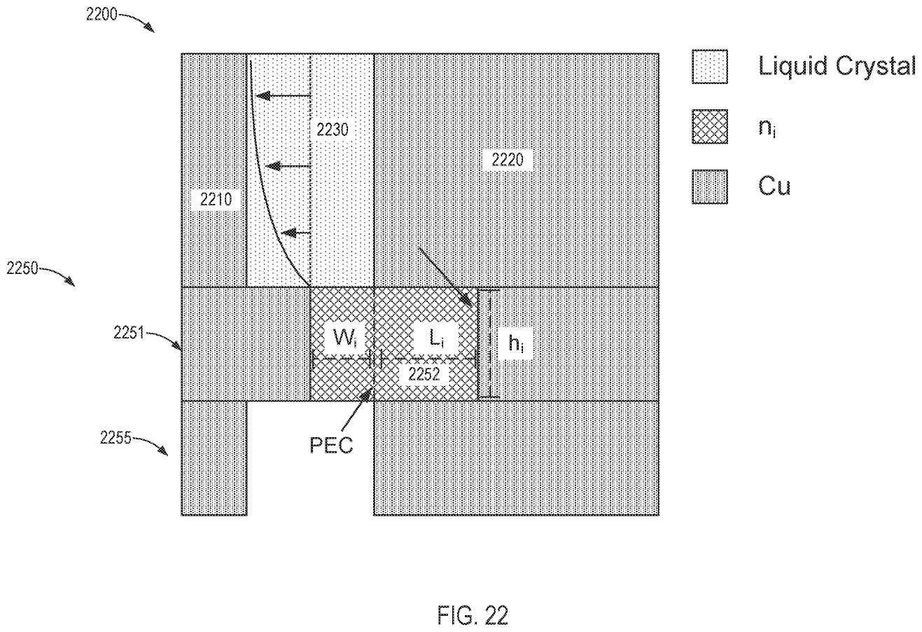

FIG. 22 illustrates a block diagram of a portion of a coaxial resonator metamaterial element 2200 with an optical isolation structure 2250 (also referred to as an optical isolation layer), according to one embodiment. According to various embodiments, in-reflection metasurfaces may utilize coaxial resonator metamaterial elements 2200 with optical isolations structures 2250 to reduce backscattering. The optical isolation structure 2250 allows a DC voltage bias to be applied between a core 2220 and an outer layer 2210, while preventing any optical field at the operating wavelength, λ, from propagating through the length of the coaxial resonator metamaterial element 2200. In so doing, the optical isolation structure 2250 creates an approximate PEC boundary condition at the lower end of the single coaxial resonator.

As illustrated, the optical isolation structure 2250 can contain two layers of metal and dielectric patterns. An upper layer 2251 contains a region 2252 that is filled with a dielectric (nᵢ) that is bounded on the upper and lower surfaces by metal boundaries. Specifically, the region 2252 is bounded by the ground plane of the coaxial resonator metamaterial element 2200 and a lower layer 2255 of the optical isolation structure 2250. These two boundaries form a parallel-plate waveguide region, which is terminated in metal at an ultimate radius from the center structure with metal that connects the upper and lower surfaces. The distance between this ultimate radius and the opening of the coaxial resonator is labelled Li, and is approximately one quarter of the wavelength inside the dielectric, Lᵢ=λ/4nᵢ.

Setting the ultimate radius equal to this value causes this layer to function analogously to a quarter wave impedance transformer, transforming the PEC boundary condition at the ultimate radius of the optical isolation structure 2250 into an approximate PMC boundary condition at the inner radius of the parallel plate waveguide region. The integrity of the approximate PMC boundary condition generated by the quarter wave impedance transformer depends on the thickness, labeled hᵢ, of the upper isolation layer 2251.

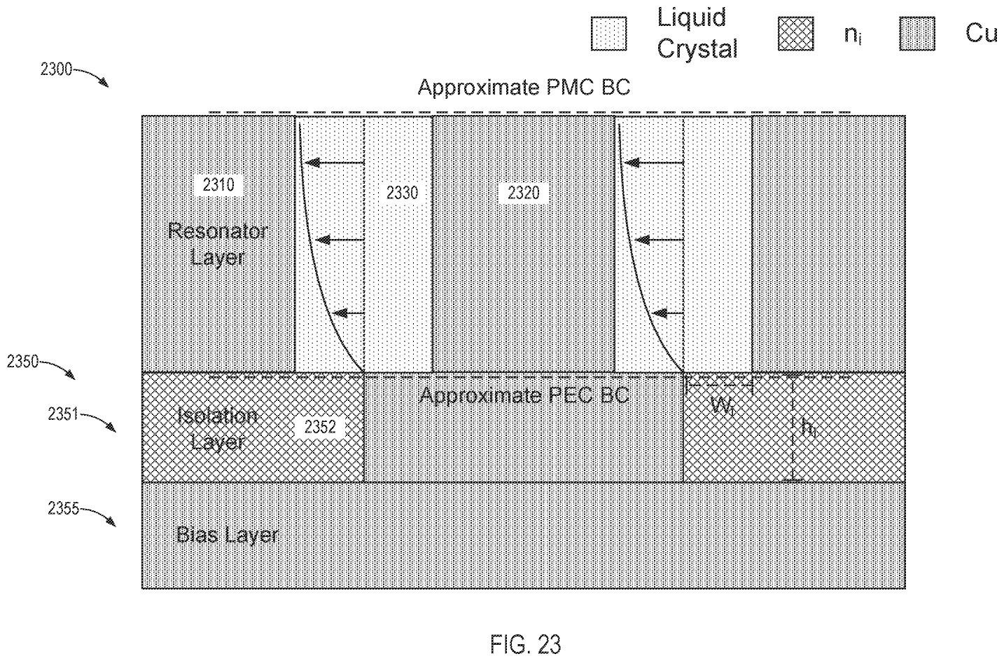

FIG. 23 illustrates a block diagram of another embodiment of a coaxial resonator metamaterial element 2300 with an optical isolation structure 2350, according to one embodiment. As illustrated, a bias layer 2355 can be commonly shared by all of the individual coaxial resonator metamaterial elements in a local array or subset of a metasurface. The metasurface may have multiple subsets of coaxial resonator metamaterial elements 2300, where each subset shares a bias layer 2355. The parameters wᵢ and hᵢ adjust the effective boundary condition between an isolation layer 2352 and a resonator layer, including an outer metal layer 2310, liquid crystal within a cavity 2330, and a core 2320.

According to various embodiments, the parameters wᵢ and hᵢ can be numerically optimized (e.g., via simulations or calculations) until the field shows that an approximate PEC boundary condition has been achieved. A PEC boundary condition simultaneously occurs with a maximum in the quality factor of the resonance frequency, since a PEC boundary condition at the bottom of the resonator layer will minimize the loss of energy from the cavity 2330 to waveguide modes in the isolation layer 2352.

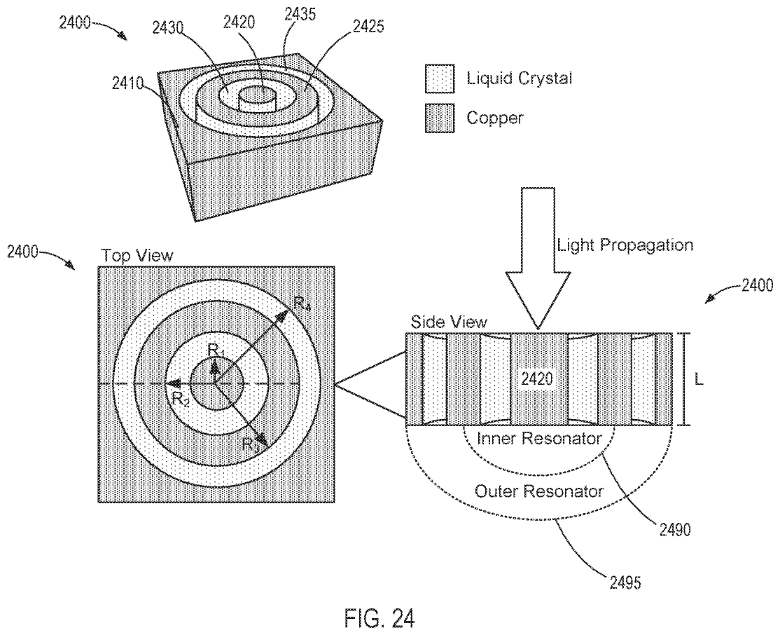

FIG. 24 illustrates various views of a bicoaxial resonator metamaterial element 2400 with two concentric cavities 2430 and 2435 that are each filled with liquid crystal, according to one embodiment. A metasurface having an array or other arrangement of bicoaxial resonator metamaterial elements 2400 can be used to achieve complete control of the phase and amplitude of reflected or transmitted light. The illustrated bicoaxial resonator element 2400 includes an outer shell 2410 of metal (e.g., copper), and two concentric coaxial cavities 2430 and 2435. A center core 2420 of metal is surrounded by a ring of copper 2425 that divides the coaxial cavities 2430 and 2435. The outer shell of the first, inner coaxial resonator 2490 serves as the inner core of the second, outer resonator 2495. The design parameters of the radii, R₁, R₂, and R₃ of the coaxial components and the overall thickness, L, are selected to achieve target resonance values for the first inner resonator 2490 and the second, outer resonator 2495. Each coaxial resonator 2490 and 2495 can be independently and dynamically tuned by varying the voltage across each coaxial resonator metamaterial element (e.g., via application of different voltages to core 2420, dividing ring 2425, and/or outer shell 2410, which varies the refractive index of the liquid crystal therein.

The actual resonances of each of the inner 2490 and outer 2495 resonators are set through the dimensions of the structure (R₁, R₂, and R₃, and L), as well as the permittivities of the materials. In some embodiments, each of the coaxial resonators 2490 and 2495 is configured to serve a different purpose. For example, the inner resonator 2490 may be designed to primarily control the amplitude of the scattered light, whereas the outer resonator 2495 may be configured to primarily alter the phase of the light. While there may be some variation in both phase and amplitude for each resonator tuning, this can be compensated by the other resonator. In various embodiments, a metasurface formed with an arrangement of bicoaxial resonator metamaterial elements provides an increased amplitude contrast and larger range of phase tuning than some embodiments of single-ring coaxial resonator metamaterial elements.

This disclosure has been made with reference to various exemplary embodiments, including the best mode. However, those skilled in the art will recognize that changes and modifications may be made to the exemplary embodiments without departing from the scope of the present disclosure. While the principles of this disclosure have been shown in various embodiments, many modifications of structure, arrangements, proportions, elements, materials, and components may be adapted for a specific environment and/or operating requirements without departing from the principles and scope of this disclosure. These and other changes or modifications are intended to be included within the scope of the present disclosure.

This disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element.

What is claimed is:

1. A dynamically tunable resonant structure, comprising:
a planar layer of a first conductive material to form an outer shell;
a cavity formed in the first conductive material that extends through the first conductive material between a first planar surface of the first conductive material and a second, opposing planar surface of the first conductive material;
a second conductive material that is placed within the cavity and extends between the first planar surface and second, opposing planar surface of the first conductive material; and
liquid crystal deposited within the cavity, wherein a refractive index of the liquid crystal changes in response to changes in an applied voltage differential between a coaxial core of the second conductive material and the first conductive material.

2. The dynamically tunable resonant structure of claim 1, wherein the first conductive material and the second conductive material are the same conductive material.

3. The dynamically tunable resonant structure of claim 1, wherein the first conductive material and the second conductive material each comprise at least one metal selected from a group of metals that includes copper, tin, gold, silver, titanium, aluminum, zinc, nickel, platinum, beryllium, rhodium, magnesium, and iridium.

4. The dynamically tunable resonant structure of claim 1, wherein the cavity formed in the first conductive material is cylindrical, and
wherein the second conductive material is a cylinder, and wherein the cylinder has an axis aligned perpendicular to the first planar surface of the first conductive material.

5. The dynamically tunable resonant structure of claim 1, wherein the cavity is ring-shaped, and wherein the second conductive material is coaxial with the ring-shaped cavity.

6. The dynamically tunable resonant structure of claim 1, wherein a length between the first planar surface and the opposing, second planar surface of the first conductive material is between 50 and 500 nanometers.

7. The dynamically tunable resonant structure of claim 1, wherein the cavity formed in the first conductive material is cylindrical,
wherein the second conductive material is a cylinder that is coaxial with the cylindrical cavity,
wherein the length between the first planar surface and the opposing, second planar surface of the first conductive material is between 50 and 500 nanometers,
wherein a radius of the cavity is between 25 and 225 nanometers, and
wherein the second conductive material cylinder has a radius that is less than the radius of the cavity and is between 24 nanometers and 224 nanometers.

8. The dynamically tunable resonant structure of claim 1, further comprising an optical isolation structure on the second, opposing planar surface that prevents optical radiation from passing through the cavity.

9. A metasurface, comprising:
a plurality of dynamically tunable resonant structures, wherein each dynamically tunable resonant structure comprises:
a first conductive material to form an outer shell,
a cavity formed in the first conductive material that extends through the first conductive material between a first surface of the first conductive material and a second, opposing surface of the first conductive material,
a second conductive material with an axis parallel to an axis of the cavity and extending between the first surface and second, opposing surface of the first conductive material, and
liquid crystal deposited within the cavity, wherein a refractive index of the liquid crystal changes in response to changes in an applied voltage differential between the second conductive material and the first conductive material; and
a controller to:
identify a pattern of surface currents to generate on the metasurface to achieve a target field within a region of space proximate to the metasurface, and
selectively apply a pattern of distinct voltages to the second conductive material of at least some of the of the dynamically tunable resonant structures to generate the identified pattern of surface currents to produce the target field within the region of space proximate the metasurface.

10. The metasurface of claim 9, wherein the first conductive material and the second conductive material of each dynamically tunable resonant structure are the same material.

11. The metasurface of claim 9, wherein the first conductive material and the second conductive material of each dynamically tunable resonant structure each comprises at least one metal selected from a group of metals that includes copper, tin, gold, silver, titanium, aluminum, zinc, nickel, platinum, beryllium, rhodium, magnesium, and iridium.

12. A tunable resonant structure, comprising:
a first resonant layer that includes:
a conductive outer shell,
a cavity formed in the conductive outer shell that is filled with liquid crystal, and
a conductive core within the cavity and with an axis parallel to an axis of the cavity; and
a second, optical isolation layer comprising a dielectric that at least partially overlaps the liquid crystal in the cavity.

13. The tunable resonant structure of claim 12, wherein the cavity is ring-shaped, and wherein the dielectric of the second, optical isolation layer is ring-shaped.

14. The tunable resonant structure of claim 13, wherein the ring-shaped dielectric of the second, optical isolation layer has a larger radius than the ring-shaped cavity and is coaxial with the ring-shaped cavity, such that a portion of the ring-shaped dielectric overlaps the conductive outer shell, and another portion of the ring-shaped dielectric overlaps the liquid crystal in the ring-shaped cavity.

15. The tunable resonant structure of claim 12, further comprising a bias layer that is electrically coupled to the conductive core through a conductive portion of the second, optical isolation layer.

16. The tunable resonant structure of claim 12, wherein the conductive outer shell and the conductive core comprise copper.

17. The tunable resonant structure of claim 12, wherein application of a voltage differential between the conductive core and the conductive outer shell causes the liquid crystal to rotate within the cavity, and
wherein rotation of the liquid crystal within the ring-shaped cavity changes resonance properties of the tunable resonant structure, such that variations in the applied voltage differential correspond to variations in the resonance properties of the tunable resonant structure.

18. A bicoaxial resonator structure, comprising:
an outer conductive shell with an aperture formed therethrough that extends from a first surface of the outer conductive shell to a second, opposing surface of the outer conductive shell;
a core having a first radius, R1, that extends though the aperture from the first surface to the second, opposing surface of the outer conductive shell;
a first ring-shaped resonant cavity that extends through the aperture and has a width defined by the first radius, R1, to a second radius, R2, wherein the first ring-shaped resonant cavity is filled with liquid crystal and is coaxial with the core;
a ring-shaped conductor that extends through the aperture and has a width defined by the second radius, R2, to a third radius, R3, wherein the ring-shaped conductor is coaxial with the core; and
a second, ring-shaped resonant cavity that extends through the aperture and has a width defined by the third radius, R3, to a radius of the aperture of the outer conductive shell, wherein the second ring-shaped resonant cavity is filled with liquid crystal and is coaxial with the ring-shaped conductor.

19. The bicoaxial resonator structure of claim 18, wherein the core is one of:
cylindrical, wherein the first ring-shaped resonant cavity, the ring-shaped conductor, and the second ring-shaped resonant cavity comprise concentric circular ring-shapes, and
rectangular, wherein the first ring-shaped resonant cavity, the ring-shaped conductor, and the second ring-shaped resonant cavity comprise concentric rectangular ring-shapes.

20. The bicoaxial resonator structure of claim 18, wherein the cavities and conductors are related by a homeomorphism to the bicoaxial resonator structure.

21. The bicoaxial resonator structure of claim 18, wherein the core, the outer conductive shell, and the ring-shaped conductor each comprises a metal.

22. The bicoaxial resonator structure of claim 18, wherein the core and the ring-shaped conductor are formed via removal of material to form the first and second ring-shaped resonant cavities.

23. The bicoaxial resonator structure of claim 18, further comprising a substrate on which each of the core, the outer conductive shell, and the ring-shaped conductor are positioned.

24. The bicoaxial resonator structure of claim 18, further comprising an optical isolation structure that prevents optical radiation from passing through the bicoaxial resonator structure via the first and second ring-shaped resonant cavities filled with liquid crystal.

25. The bicoaxial resonator structure of claim 18, further comprising a voltage controller to apply a first voltage to the core and a second voltage to the ring-shaped conductor, such that a refractive index of the liquid crystal within the first ring-shaped resonant cavity is modified to be different than a refractive index of the liquid crystal within the second ring-shaped resonant cavity.
